(19) United States
(12) Patent Application Publication
(10) Pub. No.: US 2026/0133836 A1
(43) Pub. Date: May 14, 2026

(54) THUMBNAIL PERSONALIZATION FOR CONTENT DISCOVERY

(71) Applicant: Roblox Corporation, San Mateo, CA (US)

(72) Inventors: Zhenyu ZHAO, San Mateo, CA (US); Yexi JIANG, Menlo Park, CA (US); Chen Zheng, San Mateo, CA (US); David ZHANG, San Mateo, CA (US); Peter YANG, San Mateo, CA (US); Haowen CAO, San Mateo, CA (US); Xiaohong GONG, Sunnyvale, CA (US); Patricia MORALES, San Mateo, CA (US); Anthony LIU, San Mateo, CA (US); Wenqi YAO, San Mateo, CA (US); Iris WANG, San Mateo, CA (US); Phoebe LIN, San Mateo, CA (US); Sui HUANG, San Mateo, CA (US); Tong YIN, San Mateo, CA (US); Nipun PARASRAMPURIA, San Francisco, CA (US); Jinlong JI, San Mateo, CA (US); Sean SCARNECCHIA, San Mateo, CA (US); Peter TURNER, San Mateo (CA); Dhivya VIJAYAKUMAR, San Mateo, CA (US)

(73) Assignee: Roblox Corporation, San Mateo, CA (US)

(21) Appl. No.: 19/248,161

(22) Filed: Jun. 24, 2025

Related U.S. Application Data
(60) Provisional application No. 63/718,897, filed on Nov. 11, 2024.

(51) Int. Cl. G06F 9/50

(52) U.S. Cl. CPC G06F 9/5027

(57) ABSTRACT

According to one aspect of the present disclosure, a method of thumbnail personalization is provided. The method includes initializing a thumbnail-personalization engine that includes a multi-armed bandit (MAB) model. The method includes allocating first user traffic to the plurality of thumbnails. The method includes calculating a first thumbnail-conversion rate of each thumbnail of the plurality of thumbnails based on performance data associated with the first user traffic. The method includes allocating second user traffic to the plurality of thumbnails based on the first thumbnail-conversion rate. The method includes calculating a second thumbnail-conversion rate of the plurality of thumbnails based on performance data associated with the second user traffic. The method includes determining an updated set of parameters for each arm of the MAB model based on a data decay function or a sliding-window period applied to the first thumbnail-conversion rate and the second thumbnail-conversion rate.

### CROSS-REFERENCE TO RELATED APPLICATIONS

This application is a non-provisional application that claims priority under 35 U.S.C. § 119(e) to U.S. Provisional Patent Application No. 63/718,897, filed on Nov. 11, 2024, the contents of which are hereby incorporated by reference herein in its entirety.

### TECHNICAL FIELD

Embodiments relate generally to online virtual experience platforms, and more particularly, to methods, systems, and computer readable media to provide a recommender system for thumbnail personalization.

### BACKGROUND

Recommender systems are a tool to identify relevant items for a user. A recommender system aims to surface relevant content items to users efficiently. For a platform that includes a large number of content items, running into hundreds of thousands or millions, and a diverse user base spanning many accounts and running into millions of users, recommending the content items that are most likely to result in game-play retention, improved engagement, and satisfaction with game-play experience for individual users is useful.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a computer-implemented method of thumbnail personalization is provided. The computer-implemented method includes initializing, by a processor, a thumbnail-personalization engine that includes a multi-armed bandit (MAB) model. Each arm in the MAB model corresponds to a respective thumbnail of a plurality of thumbnails associated with a virtual experience and a respective initial user cohort of a plurality of initial user cohorts. The computer-implemented method includes allocating, by the processor, first user traffic to the plurality of thumbnails. Each thumbnail receives a respective proportion of the first user traffic. The computer-implemented method includes calculating, by the processor, a first thumbnail-conversion rate of each thumbnail of the plurality of thumbnails based on performance data associated with the first user traffic. The computer-implemented method includes allocating, by the processor, second user traffic to the plurality of thumbnails based on the first thumbnail-conversion rate such that the MAB model allocates a larger proportion of the second user traffic to a first thumbnail of the plurality of thumbnails with a highest first thumbnail-conversion rate and a smaller proportion of the second user traffic to a second thumbnail of the plurality of thumbnails with a lower first thumbnail-conversion rate. The computer-implemented method includes calculating, by the processor, a second thumbnail-conversion rate of the plurality of thumbnails based on performance data associated with the second user traffic. The computer-implemented method includes determining, by the processor, at least one of: an updated set of parameters for each arm of the MAB model based on a data decay function applied to the first thumbnail-conversion rate associated with the first user traffic and the second thumbnail-conversion rate associated with the second user traffic; or the updated set of parameters for each arm of the MAB model based on the first thumbnail-conversion rate associated with a portion of the first user traffic that falls within a sliding-window period and the second thumbnail-conversion rate associated with the second user traffic.

In some implementations, the computer-implemented method further includes receiving, by the processor, the plurality of thumbnails from a client device associated with a content creator. In some implementations, the computer-implemented method further includes generating, by the processor, thumbnail-performance information based on the second thumbnail-conversion rate. In some implementations, the computer-implemented method further includes displaying, by the processor, a user interface that includes the thumbnail-performance information.

In some implementations, the virtual experience is hosted on a virtual experience platform, and the virtual experience is associated with a particular content creator. In some implementations, displaying the user interface includes displaying the user interface at the client device to the content creator.

In some implementations, allocating the first user traffic to the plurality of thumbnails includes assigning, by the processor, each user associated with the first user traffic to a corresponding initial user cohort of a plurality of initial user cohorts based on at least one first user attribute associated with the user. In some implementations, allocating the first user traffic to the plurality of thumbnails includes allocating, by the processor, respective portions of the first user traffic to respective thumbnails of the plurality of thumbnails based on the corresponding initial user cohort such that the plurality of thumbnails are allocated to the first user traffic in a uniform distribution.

In some implementations, calculating the first thumbnail-conversion rate of the plurality of thumbnails based on data associated with the first user traffic includes receiving, by the processor, first user-engagement data associated with the first user traffic. In some implementations, calculating the first thumbnail-conversion rate of the plurality of thumbnails based on data associated with the first user traffic includes, for each initial user cohort of the plurality of initial user cohorts, determining, by the processor, the first thumbnail-conversion rate of respective ones of the plurality of thumbnails based on the first user-engagement data. In some implementations, calculating the first thumbnail-conversion rate of the plurality of thumbnails based on data associated with the first user traffic includes determining, by the processor, an initial set of parameters for each arm of the MAB model based on the first thumbnail-conversion rate.

In some implementations, the computer-implemented method further includes determining, by the processor, a plurality of updated user cohorts different than the plurality of initial user cohorts based on the first user-engagement data associated with the first user traffic and a plurality of user attributes associated with the first user traffic.

In some implementations, the plurality of user attributes includes age, location, language, gender, account tenure, device platform, historical user engagement data, playtime, types of virtual experiences the user has engaged with, click-through rate on virtual-experience recommendations, or any combination thereof.

In some implementations, determining the plurality of updated user cohorts includes determining, by the processor, a respective heterogeneous incremental effect (HIE) feature importance score for each user attribute of the plurality of user attributes associated with the first user traffic based on a contribution of a particular user attribute to an incremental gain achieved by heterogeneous best arms of the MAB model compared to a global best arm of the MAB model. In some implementations, determining the plurality of updated user cohorts includes determining, by the processor, the plurality of updated user cohorts based on the respective HIE feature importance score for each user attribute of the plurality of user attributes associated with the first user traffic.

In some implementations, determining the plurality of updated user cohorts includes determining, by the processor, a respective heterogeneous distribution divergence (HDD) feature importance score for each user attribute of the plurality of user attributes associated with the first user traffic based on a distribution divergence heterogeneity introduced by a particular user attribute. In some implementations, determining the plurality of updated user cohorts includes determining, by the processor, the plurality of updated user cohorts based on the respective HDD feature importance score each user attribute of the plurality of user attributes associated with the first user traffic.

In some implementations, allocating the second user traffic to the plurality of thumbnails based on the first thumbnail-conversion rate using the MAB model includes, for each user associated with the second user traffic, determining, by the processor, a corresponding updated user cohort of the plurality of updated user cohorts based on one or more second user attributes. In some implementations, allocating the second user traffic to the plurality of thumbnails based on the first thumbnail-conversion rate using the MAB model includes allocating, by the processor, respective portions of the second user traffic to respective thumbnails of the plurality of thumbnails based the updated user cohorts.

In some implementations, calculating the second thumbnail-conversion rate of the plurality of thumbnails based on the performance data associated with the second user traffic includes receiving, by the processor, second user-engagement data associated with the second user traffic and the plurality of thumbnails. In some implementations, calculating the second thumbnail-conversion rate of the plurality of thumbnails based on the performance data associated with the second user traffic includes, for each updated user cohort of the plurality of updated user cohorts, determining, by the processor, the second thumbnail-conversion rate of the plurality of thumbnails based on the second user-engagement data.

In some implementations, determining the updated set of parameters for each arm of the MAB model based on the data decay function includes applying, by the processor, a first weighted value to the first thumbnail-conversion rate associated with the first user traffic to determine a first weighted thumbnail-conversion rate. In some implementations, determining the updated set of parameters for each arm of the MAB model based on the data decay function includes applying, by the processor, a second weighted value to the second thumbnail-conversion rate associated with the second user traffic to determine a second weighted thumbnail-conversion rate. The second weighted value is larger than the first weighted value. In some implementations, determining the updated set of parameters for each arm of the MAB model based on the data decay function includes determining, by the processor, the updated set of parameters for each arm of the MAB model based on the first weighted thumbnail-conversion rate and the second weighted thumbnail-conversion rate.

According to another aspect of the present disclosure, a non-transitory computer-readable medium storing instructions is provided. The instructions, which when executed by a processor of a virtual-experience server, cause the processor of the virtual-experience server to perform operations. The operations include initializing, by a processor, a thumbnail-personalization engine that include a multi-armed bandit (MAB) model. Each arm in the MAB model corresponds to a respective thumbnail of a plurality of thumbnails associated with a virtual experience and a respective initial user cohort of a plurality of initial user cohorts. The operations include allocating, by the processor, first user traffic to the plurality of thumbnails. Each thumbnail receives a respective proportion of the first user traffic. The operations include calculating, by the processor, a first thumbnail-conversion rate of each thumbnail of the plurality of thumbnails based on performance data associated with the first user traffic. The operations include allocating, by the processor, second user traffic to the plurality of thumbnails based on the first thumbnail-conversion rate such that the MAB model allocates a larger proportion of the second user traffic to a first thumbnail of the plurality of thumbnails with a highest first thumbnail-conversion rate and a smaller proportion of the second user traffic to a second thumbnail of the plurality of thumbnails with a lower first thumbnail-conversion rate. The operations include calculating, by the processor, a second thumbnail-conversion rate of the plurality of thumbnails based on performance data associated with the second user traffic. The operations include determining, by the processor, least one of: an updated set of parameters for each arm of the MAB model based on a data decay function applied to the first thumbnail-conversion rate associated with the first user traffic and the second thumbnail-conversion rate associated with the second user traffic; or the updated set of parameters for each arm of the MAB model based on the first thumbnail-conversion rate associated with a portion of the first user traffic that falls within a sliding-window period and the second thumbnail-conversion rate associated with the second user traffic.

In some implementations, the operations further include receiving, by the processor, the plurality of thumbnails from a client device associated with a content creator. In some implementations, the operations further include generating, by the processor, thumbnail-performance information based on the second thumbnail-conversion rate. In some implementations, the operations further include displaying, by the processor, a user interface that include the thumbnail-performance information.

In some implementations, the virtual experience is hosted on a virtual experience platform, and the virtual experience is associated with a particular content creator. In some implementations, displaying the user interface include displaying the user interface at the client device to the content creator.

In some implementations, allocating the first user traffic to the plurality of thumbnails include assigning, by the processor, each user associated with the first user traffic to a corresponding initial user cohort of a plurality of initial user cohorts based on at least one first user attribute associated with the user. In some implementations, allocating the first user traffic to the plurality of thumbnails include allocating, by the processor, respective portions of the first user traffic to respective thumbnails of the plurality of thumbnails based on the corresponding initial user cohort such that the plurality of thumbnails are allocated to the first user traffic in a uniform distribution.

In some implementations, calculating the first thumbnail-conversion rate of the plurality of thumbnails based on data associated with the first user traffic include receiving, by the processor, first user-engagement data associated with the first user traffic. In some implementations, calculating the first thumbnail-conversion rate of the plurality of thumbnails based on data associated with the first user traffic include, for each initial user cohort of the plurality of initial user cohorts, determining, by the processor, the first thumbnail-conversion rate of respective ones of the plurality of thumbnails based on the first user-engagement data. In some implementations, calculating the first thumbnail-conversion rate of the plurality of thumbnails based on data associated with the first user traffic include determining, by the processor, an initial set of parameters for each arm of the MAB model based on the first thumbnail-conversion rate.

In some implementations, the operations further include determining, by the processor, a plurality of updated user cohorts different than the plurality of initial user cohorts based on the first user-engagement data associated with the first user traffic and a plurality of user attributes associated with the first user traffic.

In some implementations, the plurality of user attributes includes age, location, language, gender, account tenure, device platform, historical user engagement data, playtime, types of virtual experiences the user has engaged with, click-through rate on virtual-experience recommendations, or any combination thereof.

In some implementations, determining the plurality of updated user cohorts include determining, by the processor, a respective heterogeneous incremental effect (HIE) feature importance score for each user attribute of the plurality of user attributes associated with the first user traffic based on a contribution of a particular user attribute to an incremental gain achieved by heterogeneous best arms of the MAB model compared to a global best arm of the MAB model. In some implementations, determining the plurality of updated user cohorts include determining, by the processor, the plurality of updated user cohorts based on the respective HIE feature importance score for each user attribute of the plurality of user attributes associated with the first user traffic.

In some implementations, determining the plurality of updated user cohorts include determining, by the processor, a respective heterogeneous distribution divergence (HDD) feature importance score for each user attribute of the plurality of user attributes associated with the first user traffic based on a distribution divergence heterogeneity introduced by a particular user attribute. In some implementations, determining the plurality of updated user cohorts include determining, by the processor, the plurality of updated user cohorts based on the respective HDD feature importance score each user attribute of the plurality of user attributes associated with the first user traffic.

In some implementations, allocating the second user traffic to the plurality of thumbnails based on the first thumbnail-conversion rate using the MAB model include, for each user associated with the second user traffic, determining, by the processor, a corresponding updated user cohort of the plurality of updated user cohorts based on one or more second user attributes. In some implementations, allocating the second user traffic to the plurality of thumbnails based on the first thumbnail-conversion rate using the MAB model include allocating, by the processor, respective portions of the second user traffic to respective thumbnails of the plurality of thumbnails based the updated user cohorts.

In some implementations, calculating the second thumbnail-conversion rate of the plurality of thumbnails based on the performance data associated with the second user traffic include receiving, by the processor, second user-engagement data associated with the second user traffic and the plurality of thumbnails. In some implementations, calculating the second thumbnail-conversion rate of the plurality of thumbnails based on the performance data associated with the second user traffic include, for each updated user cohort of the plurality of updated user cohorts, determining, by the processor, the second thumbnail-conversion rate of the plurality of thumbnails based on the second user-engagement data.

In some implementations, determining the updated set of parameters for each arm of the MAB model based on the data decay function include applying, by the processor, a first weighted value to the first thumbnail-conversion rate associated with the first user traffic to determine a first weighted thumbnail-conversion rate. In some implementations, determining the updated set of parameters for each arm of the MAB model based on the data decay function include applying, by the processor, a second weighted value to the second thumbnail-conversion rate associated with the second user traffic to determine a second weighted thumbnail-conversion rate. The second weighted value is larger than the first weighted value. In some implementations, determining the updated set of parameters for each arm of the MAB model based on the data decay function include determining, by the processor, the updated set of parameters for each arm of the MAB model based on the first weighted thumbnail-conversion rate and the second weighted thumbnail-conversion rate.

According to a further aspect of the present disclosure, a computing device is provided. The computing device includes a processor and memory storing instructions. The memory storing instructions, which when executed by the processor, cause the processor to perform operations. The operations include initializing, by a processor, a thumbnail-personalization engine that include an MAB model. Each arm in the MAB model corresponds to a respective thumbnail of a plurality of thumbnails associated with a virtual experience and a respective initial user cohort of a plurality of initial user cohorts. The operations include allocating, by the processor, first user traffic to the plurality of thumbnails. Each thumbnail receives a respective proportion of the first user traffic. The operations include calculating, by the processor, a first thumbnail-conversion rate of each thumbnail of the plurality of thumbnails based on performance data associated with the first user traffic. The operations include allocating, by the processor, second user traffic to the plurality of thumbnails based on the first thumbnail-conversion rate such that the MAB model allocates a larger proportion of the second user traffic to a first thumbnail of the plurality of thumbnails with a highest first thumbnail-conversion rate and a smaller proportion of the second user traffic to a second thumbnail of the plurality of thumbnails with a lower first thumbnail-conversion rate. The operations include calculating, by the processor, a second thumbnail-conversion rate of the plurality of thumbnails based on performance data associated with the second user traffic. The operations include determining, by the processor, at least one of: an updated set of parameters for each arm of the MAB model based on a data decay function applied to the first thumbnail-conversion rate associated with the first user traffic and the second thumbnail-conversion rate associated with the second user traffic; or the updated set of parameters for each arm of the MAB model based on the first thumbnail-conversion rate associated with a portion of the first user traffic that falls within a sliding-window period and the second thumbnail-conversion rate associated with the second user traffic.

In some implementations, the operations further include receiving, by the processor, the plurality of thumbnails from a client device associated with a content creator. In some implementations, the operations further include generating, by the processor, thumbnail-performance information based on the second thumbnail-conversion rate. In some implementations, the operations further include displaying, by the processor, a user interface that include the thumbnail-performance information.

In some implementations, the virtual experience is hosted on a virtual experience platform, and the virtual experience is associated with a particular content creator. In some implementations, displaying the user interface include displaying the user interface at the client device to the content creator.

In some implementations, allocating the first user traffic to the plurality of thumbnails include assigning, by the processor, each user associated with the first user traffic to a corresponding initial user cohort of a plurality of initial user cohorts based on at least one first user attribute associated with the user. In some implementations, allocating the first user traffic to the plurality of thumbnails include allocating, by the processor, respective portions of the first user traffic to respective thumbnails of the plurality of thumbnails based on the corresponding initial user cohort such that the plurality of thumbnails are allocated to the first user traffic in a uniform distribution.

In some implementations, calculating the first thumbnail-conversion rate of the plurality of thumbnails based on data associated with the first user traffic include receiving, by the processor, first user-engagement data associated with the first user traffic. In some implementations, calculating the first thumbnail-conversion rate of the plurality of thumbnails based on data associated with the first user traffic include, for each initial user cohort of the plurality of initial user cohorts, determining, by the processor, the first thumbnail-conversion rate of respective ones of the plurality of thumbnails based on the first user-engagement data. In some implementations, calculating the first thumbnail-conversion rate of the plurality of thumbnails based on data associated with the first user traffic include determining, by the processor, an initial set of parameters for each arm of the MAB model based on the first thumbnail-conversion rate.

In some implementations, the operations further include determining, by the processor, a plurality of updated user cohorts different than the plurality of initial user cohorts based on the first user-engagement data associated with the first user traffic and a plurality of user attributes associated with the first user traffic.

In some implementations, the plurality of user attributes includes age, location, language, gender, account tenure, device platform, historical user engagement data, playtime, types of virtual experiences the user has engaged with, click-through rate on virtual-experience recommendations, or any combination thereof.

In some implementations, determining the plurality of updated user cohorts include determining, by the processor, a respective heterogeneous incremental effect (HIE) feature importance score for each user attribute of the plurality of user attributes associated with the first user traffic based on a contribution of a particular user attribute to an incremental gain achieved by heterogeneous best arms of the MAB model compared to a global best arm of the MAB model. In some implementations, determining the plurality of updated user cohorts include determining, by the processor, the plurality of updated user cohorts based on the respective HIE feature importance score for each user attribute of the plurality of user attributes associated with the first user traffic.

In some implementations, determining the plurality of updated user cohorts include determining, by the processor, a respective heterogeneous distribution divergence (HDD) feature importance score for each user attribute of the plurality of user attributes associated with the first user traffic based on a distribution divergence heterogeneity introduced by a particular user attribute. In some implementations, determining the plurality of updated user cohorts include determining, by the processor, the plurality of updated user cohorts based on the respective HDD feature importance score each user attribute of the plurality of user attributes associated with the first user traffic.

In some implementations, allocating the second user traffic to the plurality of thumbnails based on the first thumbnail-conversion rate using the MAB model include, for each user associated with the second user traffic, determining, by the processor, a corresponding updated user cohort of the plurality of updated user cohorts based on one or more second user attributes. In some implementations, allocating the second user traffic to the plurality of thumbnails based on the first thumbnail-conversion rate using the MAB model include allocating, by the processor, respective portions of the second user traffic to respective thumbnails of the plurality of thumbnails based the updated user cohorts.

In some implementations, calculating the second thumbnail-conversion rate of the plurality of thumbnails based on the performance data associated with the second user traffic include receiving, by the processor, second user-engagement data associated with the second user traffic and the plurality of thumbnails. In some implementations, calculating the second thumbnail-conversion rate of the plurality of thumbnails based on the performance data associated with the second user traffic include, for each updated user cohort of the plurality of updated user cohorts, determining, by the processor, the second thumbnail-conversion rate of the plurality of thumbnails based on the second user-engagement data.

In some implementations, determining the updated set of parameters for each arm of the MAB model based on the data decay function include applying, by the processor, a first weighted value to the first thumbnail-conversion rate associated with the first user traffic to determine a first weighted thumbnail-conversion rate. In some implementations, determining the updated set of parameters for each arm of the MAB model based on the data decay function include applying, by the processor, a second weighted value to the second thumbnail-conversion rate associated with the second user traffic to determine a second weighted thumbnail-conversion rate. The second weighted value is larger than the first weighted value. In some implementations, determining the updated set of parameters for each arm of the MAB model based on the data decay function include determining, by the processor, the updated set of parameters for each arm of the MAB model based on the first weighted thumbnail-conversion rate and the second weighted thumbnail-conversion rate.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a diagram illustrating an example thumbnail-personalization technique, according to some implementations of the present disclosure.

FIG. 3 is a diagram of a first example thumbnail-serving system during the first stage (M1), according to some implementations of the present disclosure.

FIG. 4 is a diagram of thumbnail-serving system components, according to some implementations of the present disclosure.

FIGS. 5A-5C illustrate various graphs of Thompson sampling convergence, according to some implementations of the present disclosure.

FIG. 6 is a diagram of example offline pipeline for MAB, according to some implementations of the present disclosure.

FIG. 7 is a diagram of a second example thumbnail-serving system during the second stage (M2), according to some implementations of the present disclosure.

FIG. 8 is a diagram of thumbnail-serving system components, according to some implementations of the present disclosure.

FIG. 9 is a diagram of example offline pipeline for MAB, according to some implementations of the present disclosure.

FIG. 10 is a diagram of creator-side service components, according to some implementations of the present disclosure.

FIG. 11 is a diagram of thumbnail-serving system components, according to some implementations of the present disclosure.

FIG. 12 is a diagram of thumbnail-serving system components, according to some implementations of the present disclosure.

FIGS. 13A and 13B is a flowchart of a method of thumbnail personalization, according to some implementations of the present disclosure.

FIG. 14 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various embodiments are described herein in the context of content discovery and recommendation for a 3D virtual experience or environment. Some implementations of the techniques described herein may be applied to various types of 3D environments, such as a virtual reality (VR) conference, a 3D session (e.g., an online lecture or other type of presentation involving 3D avatars), a virtual concert, an augmented reality (AR) session, or in other types of 3D environments that may include one or more users that are represented in the 3D environment by one or more 3D avatars.

A goal of content discovery and recommendation is to forge meaningful connections between users and content items they may cherish, while simultaneously ensuring that every creation on the virtual platform reaches its ideal audience, thereby creating a mutual enhancement.

One way to address this challenge is to consider the thumbnail (e.g., artwork or imagery) used to portray content items. If the thumbnail representing a content item captures something compelling to the user, then it acts as a gateway into that content item and provides the user some visual evidence for why they might enjoy engaging with it.

Through multi-armed bandit (MAB) algorithms, the thumbnail for a content item, such as a virtual experience, which results in the longest user engagement from the largest fraction of users may be identified. However, given the enormous diversity in users' tastes and preferences, it may be beneficial to identify the appropriate thumbnail for each user and/or provide for customizable thumbnails that may be tailored for particular users.

For example, a user's visual perception may play an influential role in their decision to engage with content. To elevate personalization efforts to a new level, the present techniques provide for customization of thumbnails in which creators are enabled to upload different thumbnails for the same virtual experience. Then, using an MAB model, the thumbnail for different types of users that achieves the longest user engagement is identified and served to the user. Various aspects of the thumbnail-personalization techniques described herein will now be summarized.

The thumbnail-personalization techniques described below may include a first stage (M1), a second stage (M2), and a third stage (M3).

The first stage (M1) may be viewed as an experiment used to validate thumbnail personalization for a selection of creators. During the first stage (M1), the creator thumbnail (universe_id->list of thumbnails) in the backend system is served according to the creator's selected configuration. During the first stage (M1), a limited number of creators may be supported. The first stage (M1) may include a first substage (M1a), a second substage (M1b), and an optional third substage (M1c), as follows.

The first substage (M1a) is a randomized thumbnail experiment for the selection of creators. For instance, the first substage (M1a) may be a multiple variant A/B test where a random thumbnail is served to a user. The first substage (M1a) may be used to validate the thumbnail serving logic in the backend, gather data for user cohort segmentation, mobile device enrollment (MDE), and traffic size determination for MAB.

Based on the cohorts identified and data gathered in the first substage (M1a), the thumbnails served for each cohort of users and the given experience may be personalized during the second substage (M1b). Also, during the second substage (M1b), the MAB model implementation and cohort personalization may be validated for the selected virtual experiences.

In an optional third substage (M1c), the multiple variant A/B test may be compared against non-personalized thumbnails. For instance, the results (e.g., user engagement data) of multiple variant A/B test run for cohort personalization during the second substage (M1b) may be compared against the results of serving non-personalized thumbnails for the same virtual experience. Then, the impact of thumbnail personalization on various metrics can be measured.

During the second stage (M2), thumbnail personalization built during the first stage (M1) may be scaled for all creators and virtual experiences that the creators create (or own) and that are served by a virtual experience platform. Based on user-cohort scope, MDE, traffic size, and duration, an analytics dashboard for thumbnail personalization may be generated and made accessible to creators. The analytics dashboard may indicate the success rate of the creator's uploaded thumbnails. Moreover, user engagement data and creator analytics may be obtained, and the dashboard may be validated with dummy data prior to delivery to the creators. During the second stage (M2), thumbnail personalization is served with high availability and low latency.

Contextual MAB, whereby different thumbnails are served different users based on user characteristics, may be supported during the second stage (M2) and/or an optional third stage (M3). Moreover, the offline parameter feedback loop may be upgraded to online learning.

In various implementations, different user data may be used for various techniques described herein, such as engagement with various thumbnails; metrics of engagement with virtual experiences, such as duration of participation in a virtual experience associated with a thumbnail; user profile data (e.g., user location, device type, user demographics, etc.). In all cases, user permission is obtained to collect and use user data for thumbnail personalization. Users are provided with options to allow collection and use of certain data, to exclude certain data from being collected, and to disable data collection and turn off personalization. Data collection, storage, and use is in accordance with applicable rules and regulations applicable to the virtual experience platform or other entity that implements various described techniques.

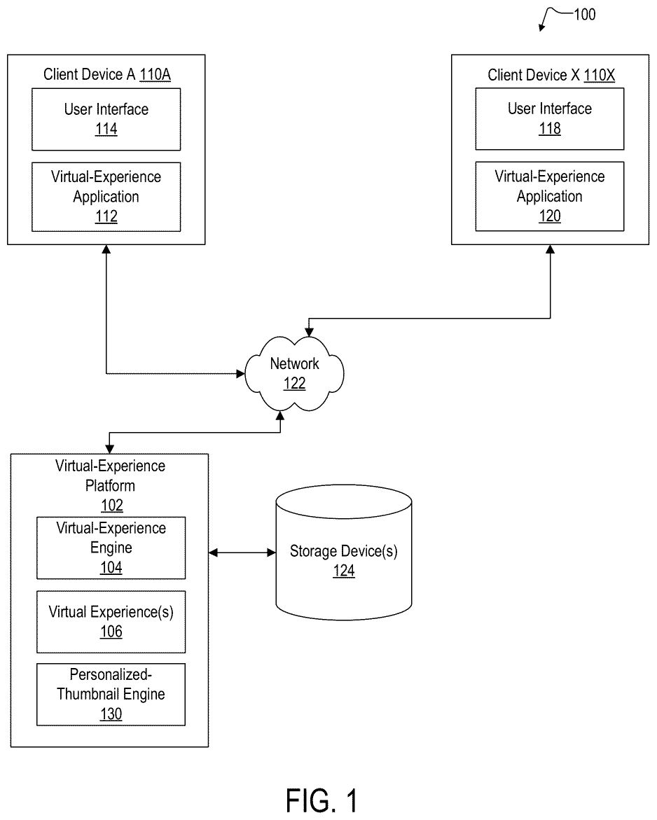

Example operations of the thumbnail-personalization techniques described herein are now described. For instance, a creator may upload thumbnails and select thumbnail personalization to begin. The MAB model allocates user traffic to these thumbnails in equal measure. The MAB model may analyze the thumbnail-conversion rate based on the data collected hourly. Then, the MAB model decides the traffic allocation for next round per user cohort. The thumbnail-conversion rate may be defined as quality conversion in which the user not only plays the game but plays the game for a certain time period. The thumbnail performance and traffic allocation information is provided to the creator on the creator-analytics dashboard. A separate process may be run daily in which human labelers or artificial intelligence models moderate clickbait images, that once detected, may be removed from the system. Additional details of the thumbnail-personalization techniques are provided below with reference to FIGS. 1-12.

### System Architecture

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, a client device 110 (or multiple client devices), and a third-party server 118, all connected via a network 122.

The online virtual experience server 102 can include, among other things, a virtual experience engine 104 and one or more virtual experiences 105. The online virtual experience server 102 may be configured to provide virtual experiences 105 to one or more client devices 110.

Data store 108 is shown coupled to online virtual experience server 102 but in some implementations, can also be provided as part of the online virtual experience server 102. The data store may, in some implementations, be configured to store advertising data, user data, engagement data, and/or other contextual data in association with the various aspects of the present disclosure. In some implementations, data store 108 and/or online virtual experience server 102 may implement various techniques described herein to provide a distributed database that supports real-time state management for a virtual 3D world (metaverse) for an increased number of users. The distributed database, in various implementations, can support spatial workloads, handle temporal data, ensure consistency, and natively support speculation. The distributed database can minimize the perceived latency even on a wide-area network.

Client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include virtual user engagement portals as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the online virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience or another GUI of the network environment 100, a user may create an avatar that includes different body parts from different libraries.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

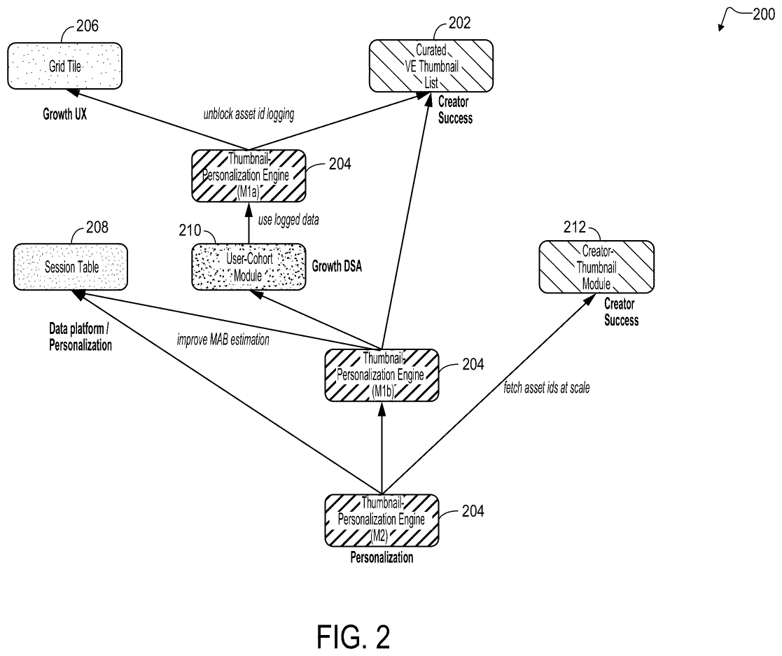

In some implementations, the online virtual experience server 102 may include a personalized-thumbnail engine 130, which may be configured to perform some or all of the operations of the thumbnail-personalization technique(s) described herein. Additional details of the operations performed by personalized-thumbnail engine 130 are provided below with reference to FIGS. 2-13B.

### Thumbnail Personalization

FIG. 2 is a diagram illustrating an example thumbnail-personalization technique 200, according to some implementations of the present disclosure.

Referring to FIG. 2, the thumbnail-personalization technique 200 may be implemented by using a combination of, e.g., a virtual experience (VE) thumbnail list module 202, a thumbnail-personalization engine 204, a grid tile 206 (located at a client device), a session table 208, a user-cohort module 210, and a creator-thumbnail module 212.

The thumbnail-personalization technique 200 may include multiple stages to optimize thumbnail personalization. One stage may be an MAB stage (e.g., a first stage (M1)), which is implemented for a set of virtual-experience creators (referred to hereinafter as “creators”). Another stage may be scalable and self-serve thumbnail cohort-based personalization stage (referred to hereinafter as a “cohort-based personalization stage”) (e.g., a second stage (M2)). There may also be a third stage (M3), as described later.

The MAB stage (M1) demonstrates the effectiveness of thumbnail personalization. The MAB stage (M1) may be broken down into a first substage (M1a) and a second substage (M1b). The first substage (M1a) may include random sampling. In the first substage (M1a), a comparison test is supported by serving randomly sampled thumbnails of a virtual experience to user traffic. The goal of the first substage (M1a) is to collect unbiased data to 1) help validate the effectiveness of MAB and 2) to better determine the user cohort. The second substage (M1b) may be implemented by running another comparison test to demonstrate the effectiveness of MAB over non-personalized thumbnail serving.

For example, at the start of the first substage stage (M1a), a creator may design and upload a plurality of different thumbnails that each correspond to the same virtual experience, which was also designed by and/or is otherwise associated with the creator. In some cases, thumbnails for the virtual experience may be automatically generated and associated for use with the virtual experience with approval of the creator. The virtual-experience server may maintain the thumbnails in a curated virtual-experience thumbnail list 202. A thumbnail-personalization engine 204 that includes a multi-armed bandit (MAB) model may be initialized, where each arm in the MAB model corresponds to a respective thumbnail of the plurality of thumbnails associated with the same virtual experience and a respective initial user cohort of a plurality of initial user cohorts. The initial user cohorts may segment users based on an initial set of user attributes, e.g., such as gender and/or age and/or other attributes (all accessed and used with specific user permission).

Still referring to the first substage (M1a), the thumbnail-personalization engine 204 may allocate first user traffic to each of the plurality of thumbnails such that each thumbnail receives a respective and equal proportion of the first user traffic. For instance, when a user accesses a virtual-experience platform using a client device (not shown), the user-cohort module 210 may determine the user cohort into which the user falls based on an initial set of user attributes.

By way of example and not limitation, during the first substage (M1a), the user cohorts may include four user cohorts: a first user cohort (e.g., male, age 17+), a second user cohort (e.g., male, age 17−), a third user cohort (e.g., female, age 17+), and a fourth user cohort (e.g., female, age 17−). Then, based on the determined user cohort, the thumbnail-personalization engine 204 may allocate the first user traffic to respective thumbnails such that each of the plurality of thumbnails are allocated to the first user traffic in a uniform distribution (e.g., an equal percentage as shown below in Table 1). The thumbnail allocated to a user may be displayed on a grid tile 206 at the user's client device (not shown). The grid tile 206 may include any structured arrangement of thumbnails. For example, the thumbnails may be arranged in rows and columns, creating a visually organized display of different virtual-experiences the user may enjoy.

Still referring to the first substage (M1a), a session table 208 may log the percentage that a thumbnail is allocated to the first user traffic for each user cohort and the performance data for each thumbnail allocated to each user cohort. Table 1, shown below, depicts a non-limiting example of the session table 208 during the first substage (M1a). In the example shown in Table 1, there are four user cohorts (e.g., Cohort 1, Cohort 2, Cohort 3, and Cohort 4) and five thumbnails (e.g., T1, T2, T3, T4, and T5). However, more or fewer than four initial cohorts and five thumbnails may be used in the first substage (M1a) without departing from the scope of the present disclosure.

TABLE 1
Percentage of Thumbnail Allocation per User Cohort during M1a

| | Cohort 1 | Cohort 2 | Cohort 3 | Cohort 4 |
|---|---|---|---|---|
| T1 | 20% | 20% | 20% | 20% |
| T2 | 20% | 20% | 20% | 20% |
| T3 | 20% | 20% | 20% | 20% |
| T4 | 20% | 20% | 20% | 20% |
| T5 | 20% | 20% | 20% | 20% |

Performance data (e.g., user-engagement data) associated with each of the thumbnails may be logged per user cohort (e.g., an hourly session table, a half-hourly session table, a daily session table, a weekly session table, etc.). The performance data may be logged at the session table 208 or at another database. The performance data may include, e.g., public test realm (PTR) engagement data, playtime, win/loss rates, game modes, and player behavior (e.g., which content items are used within the virtual experience, how a player interacts with the virtual environment, etc.), just to name a few.

To determine a first thumbnail-conversion rate for each of the creator's thumbnails served during the first substage (M1a), the performance data of the first user traffic may be calculated. In some implementations, the first thumbnail-conversion rate may be calculated using an E-greedy algorithm or Thompson sampling, as described later. A non-limiting example of the first thumbnail-conversion rate for each of the five thumbnails during the first substage (M1a) is shown below in Table 2.

TABLE 2
Example First Thumbnail-Conversion Rates during M1a

| | Cohort 1 | Cohort 2 | Cohort 3 | Cohort 4 |
|---|---|---|---|---|
| T1 | 2% | 1% | 2% | 1% |
| T2 | 1% | 2% | 1% | 1% |
| T3 | 1% | 1% | 1% | 3% |
| T4 | 1% | 1% | 1% | 1% |
| T5 | 0.5% | 0.5% | 0.5% | 0.5% |

After determining the first thumbnail-conversion rate, the thumbnail-personalization engine 204 may determine an initial set of parameters for each arm of the MAB model based on the first thumbnail conversion rate. The initial set of parameters may be determined during the first substage (M1a) or the second substage (M1b).

Moreover, during the first substage (M1a) or the second substage (M1b), the user-cohort module 210 may determine a plurality of updated user cohorts different than the plurality of initial user cohorts based on the first user-engagement data associated with the first user traffic and a plurality of user attributes associated with the first user traffic. The plurality of user attributes may include any combination of user-permitted attributes such as, e.g., age, location, language, gender, account tenure, device platform, historical user engagement data, playtime, types of virtual experiences the user has engaged with, and click-through rate on virtual-experience recommendations.

In some implementations, the user-cohort module 210 may determine the plurality of updated user cohorts based on a respective heterogeneous incremental effect (HIE) feature importance score for each user attribute of the plurality of user attributes associated with the first user traffic. The HIE feature importance score may evaluate a contribution of a particular user attribute to an incremental gain achieved by heterogeneous best arms of the MAB model compared to a global best arm of the MAB model.

In some implementations, the user-cohort module 210 may determine the plurality of updated user cohorts based on a respective heterogeneous distribution divergence (HDD) feature importance score for each user attribute of the plurality of user attributes associated with the first user traffic. The HDD feature importance score may evaluate a distribution divergence heterogeneity introduced by a particular user attribute.

The plurality of updated user cohorts may include the same number or a different number of user cohorts as compared with the initial user cohorts. In the non-limiting example used to describe FIG. 2, the same number of user cohorts are used to describe the first substage (M1a) and the second substage (M1b), but it is possible to use different numbers of user cohorts determined based on any set of user attributes without departing from the scope of the present disclosure.

During the second substage (M1b), the thumbnail-personalization engine 204 may allocate second user traffic to the plurality of thumbnails based on the first thumbnail-conversion rates associated with the first substage (M1a). The number of times a thumbnail is allocated to the second user traffic may be proportional to the first thumbnail-conversion rate associated with that user cohort. In other words, the second user traffic may be allocated to the plurality of thumbnails based on the initial set of parameters for each arm of the MAB model.

In some implementations, for each user associated with the second user traffic, a corresponding updated user cohort of the plurality of updated user cohorts may be determined based on one or more second user attributes. Respective portions of the second user traffic may be allocated to respective thumbnails of the plurality of thumbnails based the updated user cohorts. The second user attributes may be any combination of user attributes that form one of the updated user cohorts.

For example, the second user traffic may be allocated to the plurality of thumbnails based on the first thumbnail-conversion rate such that the MAB model allocates a larger proportion of the second user traffic to a first thumbnail of the plurality of thumbnails with a highest first thumbnail-conversion rate and a smaller proportion of the second user traffic to a second thumbnail of the plurality of thumbnails with a lower first thumbnail-conversion rate. The session table 208 may log the percentage (see Table 3 below) that a thumbnail is allocated to the second user traffic for each user cohort and the performance data for each thumbnail allocated to each user cohort.

TABLE 3
Percentage of Thumbnail Allocation per User Cohort during M1b

| | Cohort 1 | Cohort 2 | Cohort 3 | Cohort 4 |
|---|---|---|---|---|
| T1 | 50% | 15% | 50% | 8% |
| T2 | 15% | 50% | 15% | 8% |
| T3 | 15% | 15% | 15% | 70% |
| T4 | 15% | 15% | 15% | 8% |
| T5 | 5% | 5% | 5% | 6% |

The performance data of the second user traffic may be analyzed to calculate a second thumbnail-conversion rate for each of the creator's thumbnails served during the second substage (M1b). An example of the second thumbnail-conversion rate for each of the five thumbnails during the second substage (M1b) is shown below in Table 4.

TABLE 4
Example Second Thumbnail-Conversion Rates during M1b

| | Cohort 1 | Cohort 2 | Cohort 3 | Cohort 4 |
|---|---|---|---|---|
| T1 | 4% | 1% | 4% | 1% |
| T2 | 1% | 4% | 1% | 1% |
| T3 | 1% | 1% | 1% | 7% |
| T4 | 1% | 1% | 1% | 0.4% |
| T5 | 0.1% | 0.1% | 0.1% | 0.1% |

In some implementations, the second thumbnail-conversion rate may be calculated at predetermined intervals based on the performance data associated with the second user traffic. For example, second user-engagement data associated with the second user traffic and the plurality of thumbnails may be received, and for each updated user cohort of the plurality of updated user cohorts, the second thumbnail-conversion rate of the plurality of thumbnails may be determined based on the second user-engagement data. In some implementations, the second thumbnail-conversion rate may be determined using an E-greedy algorithm or Thompson sampling, as described later.

Then, an updated set of parameters for each arm of the MAB model may be determined by the thumbnail-personalization engine 204 based on the first thumbnail-conversion rate and the second thumbnail-conversion rate using various techniques.

For instance, as the thumbnail performance varies across time, there can be performance seasonality and decay when the thumbnail has been used for a long time. Thus, it may be beneficial to trade off recency and cumulated sample size in thumbnail-performance history to optimize the MAB model's performance. To that end, the present disclosure proposes a sliding window and/or data decay function be applied to the first thumbnail-performance data and second thumbnail-performance data to determine the training data used for updating the MAB model during the second stage (M2).

The sliding-time window or data decay function described herein helps the MAB model adapt to changing user-engagement trends by emphasizing recent performance over older, potentially outdated, data. For example, when applying Thompson sampling (which estimates each arm's reward possibility by sampling from a Bayesian posterior), using a sliding-time window ensures that only the most recent rewards update the posterior distributions. Additionally and/or alternatively, a data decay function that assigns higher weights to more recent performance data, while gradually diminishing the impact earlier data has on current thumbnail serving, may be used. Both the sliding-time window and data decay function allows the MAB model to adapt to shifts in the underlying reward distributions.

The data decay function may apply a first weighted value to the first thumbnail-conversion rate associated with the first user traffic to determine a first weighted thumbnail-conversion rate. The data decay function may apply a second weighted value to the second thumbnail-conversion rate associated with the second user traffic to determine a second weighted thumbnail-conversion rate, where the second weighted value is larger than the first weighted value. The updated set of parameters for each arm of the MAB model may be determined based on the first weighted thumbnail-conversion rate and the second weighted thumbnail-conversion rate.

Using MAB, success and failure for each arm may be counted to calculate their respective success rate. In a non-limiting example, the success rate may be calculated as success/(success+failure).

However, since the most recent data may be more representative of the current performance, and the data from longer history may no longer represent the current performance, due to non-stationary of the arm performance. Thus, the present disclosure proposes the use a weighted sum of the historical data to reflect the decay, according to equations (1)-(3) shown below.

$$Weighted arm success count = weight\_ 1 * success\_count \_last \_ 1 \_day + weight\_ 2 * success\_count \_last \_ 2 \_day += weight\_ 3 * success\_count \_last \_ 3 \_day + ... sum ( weight\_i * success\_count in the ith day from now ) for i = 1 , 2 , 3 , ... . \qquad ( 1 )$$

$$Weighted arm failure count = sum ( weight\_i * failure\_count in the ith day from now ) for i = 1 , 2 , 3 , ... . \qquad ( 2 )$$

$$Weighted success rate = Weighted arm success count / ( Weighted arm success count + Weighted arm failure count ) . \qquad ( 3 )$$

The weighted arm success count, weighted arm failure count, weighted success rate calculated according equations (1)-(3), respectively, may be used to the MAB algorithm.

The weights may decay over time, for example, weight_1=1, weight_2=0.9, weight_3=0.8, etc.

In some implementations, the updated set of parameters for each arm of the MAB model may be determined based on the first thumbnail-conversion rate associated with a portion of the first user traffic that falls within a sliding-window period and the second thumbnail-conversion rate associated with the second user traffic.

The sliding-window period is a special form of decay function, e.g., with weight_i=1 for i=1˜7, and weight_i=0 for i>7.

The sliding window period may be a seven days, fourteen days, thirty days, three-hundred and sixty-five days, etc.

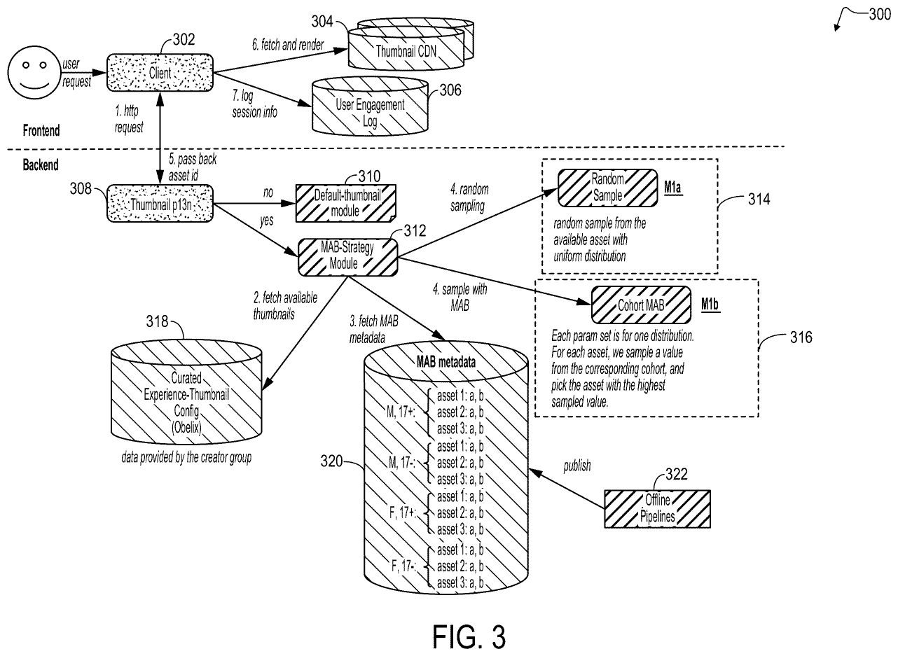

Once the data used for updating the MAB model during the second stage (M2) is determined, thumbnail personalization at the user-cohort level may be implemented, and a larger group of creators may be enabled to update the list of thumbnails via the creator-thumbnail module 212. The cohort-based personalization stage (M2) may generate solution reports for creators, so they can check the effectiveness of their thumbnails from an analytics dashboard (not shown) via the creator-thumbnail module 212. During the second stage (M2), hourly MAB updates may be implemented to improve both user and creator experience. Additional details of the thumbnail-personalization technique 200 are provided below with reference to FIGS. 3-13B.

### Example Thumbnail-Serving System for First Stage (M1)

FIG. 3 is a diagram of a first example thumbnail-serving system 300 during the first stage (M1), according to some implementations of the present disclosure.

Referring to FIG. 3, the design of the thumbnail-serving system 300 may take into account various considerations, such as, e.g., 1) MAB metadata, 2) curated experience-thumbnail configurations, 3) MAB strategy, and 4) cohort-based serving, among others. To that end, the thumbnail-serving system 300 may include, e.g., a client device 302, a thumbnail content delivery network (CDN) 304, a user-engagement log 306, a thumbnail personalization (p13n) module 308, a default-thumbnail module 310, an MAB-strategy module 312, a random sample model 314, a cohort-based MAB model 316, a curated-experience thumbnail configuration module 318, an MAB metadata database 320, and an offline pipeline module 322.

To begin, a user of client device 302 may search a category of virtual experiences for games to play or otherwise log onto a virtual-experience platform. With user permission, the user's search request may be sent to the thumbnail personalization module 308, which may determine whether there is a default thumbnail for use is presenting to the user based on the user selection. This determination may be made by querying the default-thumbnail module 310.

When there is a default thumbnail to present to the user, the thumbnail personalization module 308 may request the client device 302 fetch and render the default thumbnail from the thumbnail CDN 304.

Otherwise, when there is not a default thumbnail, the MAB-strategy module 312 may select either the random sample model 314 or the cohort-based MAB model 316 for identifying a corresponding thumbnail to present to the user, depending on whether the request is received during the first substage (M1a) or the second substage (M1b). During the first substage (M1a), the MAB-strategy module 312 may select the random sample model 314. On the other hand, the MAB-strategy module 312 may select the cohort-based MAB model 316 during the second substage (M1b).

Upon selection of the cohort-based MAB model 316, the MAB-strategy module 312 may fetch configuration information associated with a creator's thumbnails from the curated-experience thumbnail configuration database 318. The curated-experience thumbnail configuration database 318 may include a universe-to-asset identification mapping may be stored in a database table keyed by universe_id. The value may be a list of asset identifications of the target universe_id. The target universe_id may indicate the type of virtual experience requested by the user (e.g., adventure virtual-experiences, single-person shooter virtual experiences, naval virtual-experiences, etc.)

The MAB-strategy module 312 may fetch MAB metadata (e.g., training data) based on the user cohort corresponding to the user from the MAB metadata database 320. In some implementations, the MAB metadata database 320 may include a separate table keyed by universe_id. In some implementations, the value of the MAB metadata may be a JavaScript Object Notation (JSON) string with schema. Based on the MAB metadata, the MAB-strategy module 312 may identify the thumbnail from the available thumbnails to serve to the user using the cohort-based MAB model 316.

Then, the thumbnail-personalization module 308 may send the asset id for the selected thumbnail to client device 302, which then fetches the corresponding thumbnail from the thumbnail CDN 304. The thumbnail may be rendered in the corresponding grid tile at the client device 302. User engagement data associated with the virtual experience to which the thumbnail corresponds may be logged in user-engagement log 306 for thumbnail-conversion rate analysis.

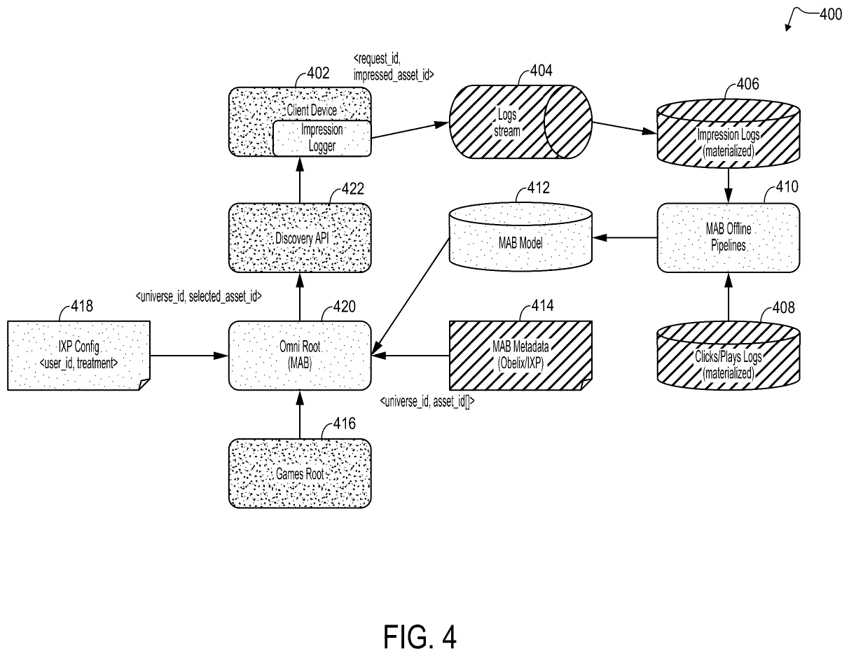

Example components to support the thumbnail-serving system 300 of FIG. 3 are described below with reference to FIG. 4.

### Example Online Serving Components for First Stage (M1)

FIG. 4 is a diagram of thumbnail-serving system components 400, according to some implementations of the present disclosure.

Referring to FIG. 4, the thumbnail-serving system components 400 may be used to update the MAB model. To that end, the thumbnail-serving system components 400 may include, e.g., a client device 402, a logs stream module 404, an impression logs module 406, a click/plays logs module 408, an MAB offline pipeline module 410, an MAB model 412, an MAB metadata database 414, a games root module 416, an IXP configuration module 418, an OmniRoot module 420, and a discover API module 422.

The client device 402 may include an impression logger that, with appropriate user permissions, logs information associated with the display of a thumbnail. The impression logger may send the impression logs to logs stream module 404. Logs stream module 404 may store impression logs more efficiently than a regular data stream module, for instance. The impression logs may be sent to the impression logs module 406, which materializes the impression logs.

Materializing impression logs refers to creating a dedicated, persistent storage for impression data, for performance reasons. This contrasts with simply storing logs in a temporary or volatile manner. Materializing impression logs may use database indexes, materialized views, or dedicated data warehousing platforms to store and analyze impression data efficiently. For example, assume the system wants to analyze impression counts by day and domain name. Instead of querying the raw log files every time, the impression data is materialized into a table with columns like date, domain_name, and impression_count. This table can then be used for fast querying and reporting.

The client device 402 may send click/plays information to clicks/plays log module 408, which may materialize the clicks/plays. The clicks/plays information may be materialized in the same or similar manner as impression logs and will not be repeated here.

The materialized impression logs and clicks/plays may be sent to MAB offline pipeline module 410. MAB offline pipeline module 410 may perform large-scale processes such as, e.g., data collection, an extract-transform-load (ETL) process, feature generation (from the collected data), model training of machine learning models (based on the generated features), etc. The MAB offline pipeline module 410 may perform these processes using the materialized impression logs and clicks/plays. For example, the materialized impression logs and clicks/plays may be used to update the training data set for MAB model 412. The various arms of the MAB model 412 may be updated based on the training data generated/updated by MAB offline pipeline module 410.

The OmniRoot module 420 may receive information about the selected thumbnail from MAB model 412, MAB metadata from MAB metadata database 414, games root information from games root module 416, and user information (e.g., such as the impression for the user and the corresponding treatment <the user_id, treatment>) from the IXP configuration module 418 (e.g., an open source hosting control panel for Linux). The OmniRoot module 420 may identify a universe_id and selected_asset_id for the selected thumbnail based on the selected thumbnail information and the MAB metadata. The MAB metadata provides a mapping of <universe_id, thumbnail_asset_id>.

This mapping may be used to determine what data will be used for the MAB algorithm: only the matched <universe_id, thumbnail_id>will be used for corresponding universe_id. An independent MAB for each universe_id, and each thumbnail_id belonging to the universe_id will be one arm.

The universe_id and selected_asset_id may be sent to the discover API module 422. The discover API module 422 may provide this information to the client device 402, which uses it to fetch and render the selected thumbnail.

### Thompson Sampling Convergence

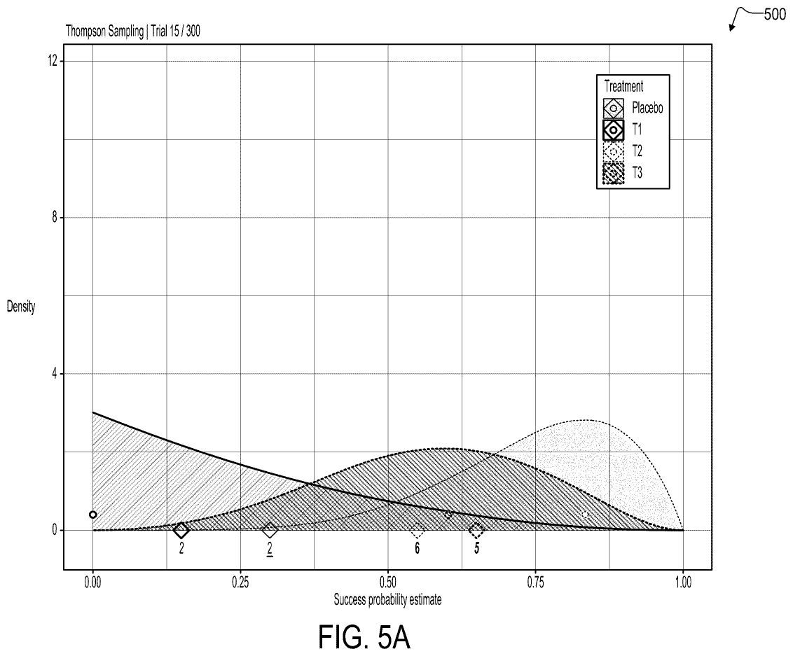

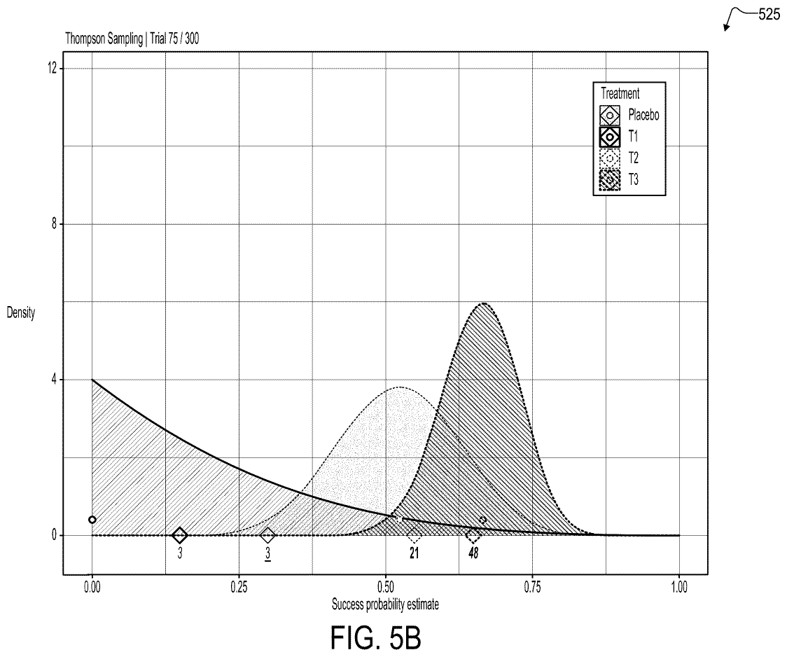

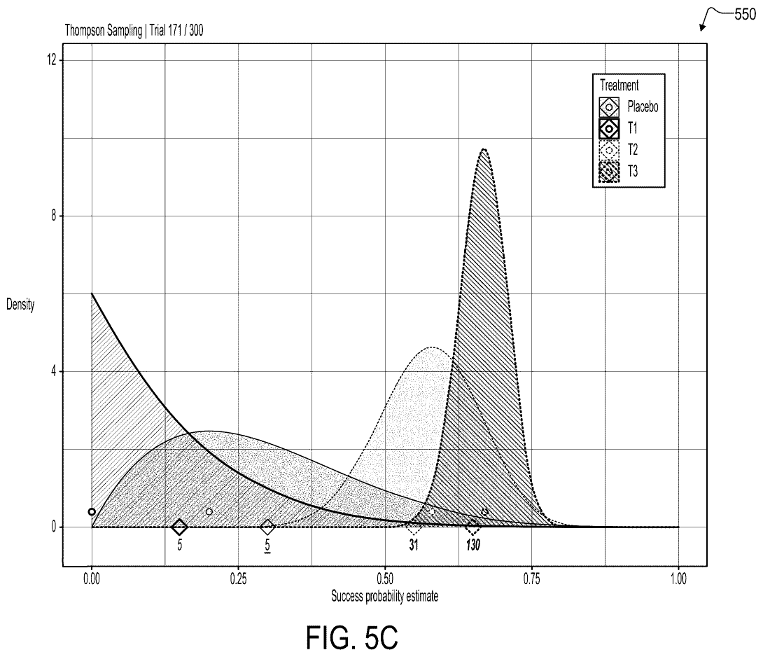

FIGS. 5A-5C illustrate various graphs 500, 525, 550 of Thompson sampling convergence, according to some implementations of the present disclosure.

The MAB strategies may be available from the second substage (M1b) described above with reference to FIG. 2. The algorithms, including Random sampling, ε-greedy, and Thompson sampling (shown in FIGS. 5A-5C), may be implemented in the MAB library for the sake of generality and reusability. When appropriate, an Upper Confidence Bound (UCB) algorithm and others can be added. The library may be imported to the homepage backend.

ε-greedy is the most intuitive MAB algorithm due to its simplicity. At a high level, ε-greedy may switch between exploration (with probability ¿) and exploitation probabilistically. For exploration, the algorithm may randomly select a thumbnail (an arm in MAB terminology) to serve the user, and then update the observation (e.g., play-through-rate (PTR)) or the pulled arm according to the user's feedback (e.g., playtime or other variable of interest). For exploitation, the algorithm may pick the candidate thumbnail with the best user feedback (e.g., highest PTR) to serve.

Using Thompson sampling, a k-arm bandit problem may have 2k parameters, (α₁, β₁) to (αₖ, βₖ). Each pair of parameters is used to quantify the Beta distribution (e.g., conjugate prior distribution of the posterior Bernoulli distribution, assuming a binary reward of click/no-click or play/no-play) of one arm. The process of Thompson sampling-based MAB can be summarized by an initialization operation, a sampling operation, an observation operation, and an updating operation.

Initialization: all (α₁, β₁) to (αₖ, βₖ) may be set to 1, indicating no prior knowledge.

Sampling: at the beginning of each round, for each arm i, a value θᵢ may be sampled from Beta(αᵢ, βᵢ), the arm j with the highest sampled value θⱼ may be selected, and the corresponding thumbnail id may be returned.

Observation: the reward rⱼ for the selected icon j may be observed, where a value of 1 indicates a positive user feedback (e.g. click, play) and 0 indicates the negative feedback.

Updating: (αⱼ, βⱼ) may be updated such that if rⱼ=1, αⱼ=αⱼ+1, and if rⱼ=0, βⱼ=βⱼ+1.

This process continues with the Thompson Sampling algorithm iteratively sampling from the Beta distributions, selecting arms, observing rewards, and updating the Beta distributions based on these rewards. Over time, the Beta distributions become more peaked around the true conversion rate of each arm, and the algorithm becomes more likely to select the arm with the highest conversion rate. As both αⱼ, βⱼ increases, the variance

$$( Variance = \frac{αβ}{{( α + β )}^{2} ( α + β + 1 )} )$$

of the corresponding beta distribution decreases.

### Example Offline Pipeline for First Stage (M1)

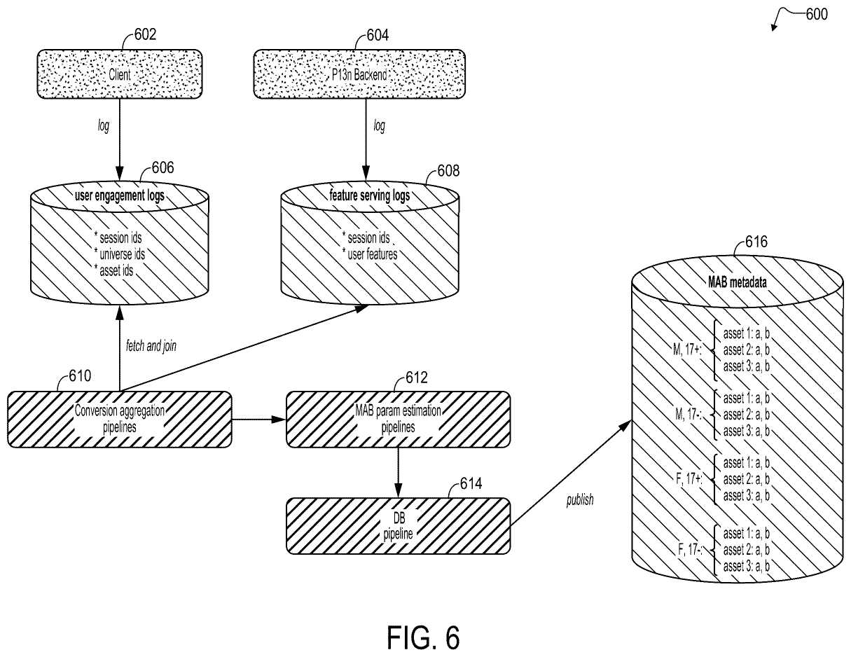

FIG. 6 is a diagram of example offline pipeline 600 for MAB, according to some implementations of the present disclosure.

Referring to FIG. 6, a goal of the offline pipeline 600 is to estimate the MAB parameters, e.g., alpha, beta for Thompson sampling, based on users' implicit or explicit feedback, etc. It may conduct aggregation and calculation based on the logged data and publishes the parameters to a database for serving. To that end, the offline pipeline 600 may include, e.g., a client device 602, a personalization (P13n) backend module 604, a user engagement logs database 606, a feature serving logs database 608, conversion aggregation pipelines module 610, an MAB parameter estimation pipelines module 612, a database (DB) pipeline 614, and an MAB metadata database 616.

The client device 602 may include an impression logger (not shown) that logs information associated with the display of a thumbnail. The client device 602 may send the impression logs to the user engagement logs database 606. The impression logs may include information such as a session identification (e.g., a particular user session of the virtual-experience platform, date, time, duration, etc.), universe identification (e.g., the category of virtual experience the user wishes to engage with such as an adventure virtual experience), and the asset identification (e.g., a specific virtual experience within the broader virtual experience category).

The personalization backend module 604 performs backend functionality that enables customization of feature serving logs (e.g., customization of tables by adjusting columns, sorting, filtering, grouping, etc.). This allows the display and behavior of performance data to be tailored for a creator's needs. The feature serving logs may be sent to feature serving logs database 608. The features maintained by feature serving logs database 608 may be used to test a new feature update to the MAB model. This feature can be computed and fetched online alongside the other features that the MAB model will use for inference. The thumbnail to be shown to the user can become the training events (impressions) and later can be joined in ground truth labels: thumbnail clicks. Because the logged set of features for each impression is available, it can be used to train the MAB model with historically accurate data.

The design of the offline pipeline 600 shown in FIG. 6 may take into account logic decoupling, configurability, and a choice of storage.

For logic decoupling, the conversion aggregation pipeline module 610 and the MAB parameter estimation pipeline module 612 are decoupled so they can evolve independently. The conversion aggregation pipeline module 610 may be tested with various conversion types and user cohorts. The MAB parameter estimation pipeline module 612 can be evolved into a model training pipeline during the second stage (M2).

The conversion aggregation pipeline module 610 and the MAB parameter estimation pipeline module 612 are designed to be configurable to facilitate MAB parameter sweeping. The MAB parameter is semi-personalized at the user cohort level. Each user cohort and each thumbnail may have a dedicated MAB model arm with parameters estimated according to the historical user engagement.

In one non-limiting example, the users may be segmented into 4 cohorts: female 17+ (e.g., greater than 17-years-old), male 17+, female 17− (e.g., less than 17-years-old), and male 17−. A preliminary sample size calculation (e.g., MAB offline evaluation metric baseline and sample size calculation) indicates that the top 500 experiences may a sufficient amount of user traffic to obtain statically-significant results. These results may be published into a database pipeline 614, as the corresponding data retrieval logic is mature on the backend side. The database pipeline 614 may publish the results to MAB metadata database 616.

### Example Online Serving Logic for Second Stage (M2)

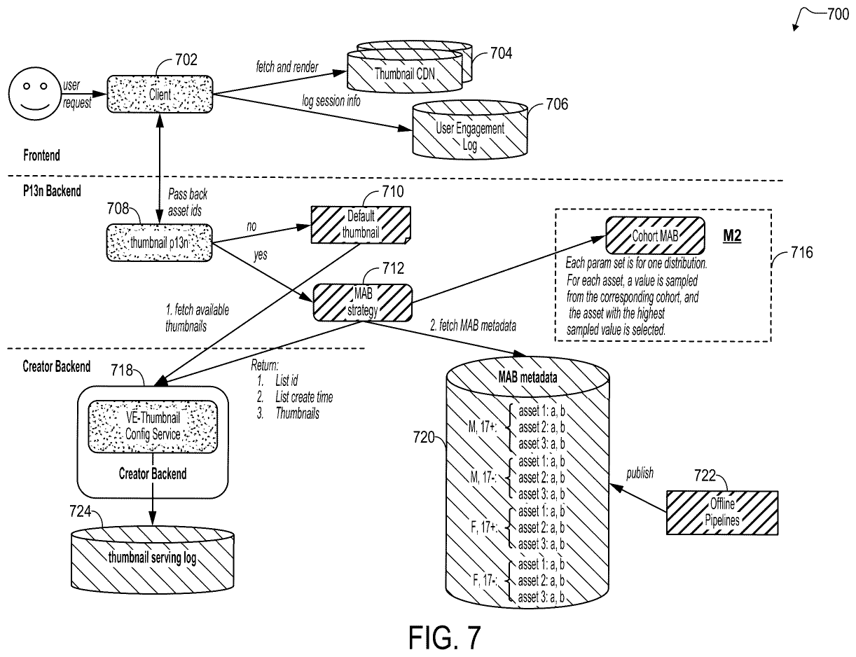

FIG. 7 is a diagram of a second example thumbnail-serving system 700 during the second stage (M2), according to some implementations of the present disclosure.

Referring to FIG. 7, the design of the thumbnail-serving system 700 may take into account various considerations, such as, e.g., 1) MAB metadata, 2) curated experience-thumbnail configurations, 3) MAB strategy, and 4) cohort-based serving, among others. To that end, the thumbnail-serving system 700 may include, e.g., a client device 702, a thumbnail content delivery network (CDN) 704, a user-engagement log database 706, a thumbnail personalization (p13n) module 708, a default thumbnail module 710, an MAB strategy module 712, a cohort-based MAB model 716, a VE-thumbnail configuration service module 718, an MAB metadata database 720, an offline pipeline module 722, and a thumbnail serving log database 724.

To begin, a user of client device 702 may search for a category of virtual experience or otherwise log onto a virtual-experience platform. With user permission, the user's request may be sent to the thumbnail personalization module 708, which may determine whether there is a default thumbnail for use is presenting to the user based on the user selection. This determination may be made by querying the default-thumbnail module 710.

When there is a default thumbnail to present to the user, the thumbnail personalization module 708 may request the client device 702 fetch and render the default thumbnail from the thumbnail CDN 704.

Otherwise, when there is not a default thumbnail, the MAB strategy module 712 may select the cohort-based MAB model 716 for identifying a corresponding thumbnail to present to the user.

Upon selection of the cohort-based MAB model 716, the MAB strategy module 712 may fetch information associated with available thumbnails for a creator's virtual experience from the VE-thumbnail configuration service module 718. To keep the setting of thumbnail personalization up-to-date, the curated-experience thumbnail configuration database 318 in FIG. 3 may be replaced with the VE-thumbnail configuration service module 718.

When a thumbnail is newly enabled for personalization, the system may gradually roll out this new thumbnail. This is because it may be less than ideal to fully roll out new thumbnails if those thumbnails have low conversion rates. Creators may create a new set of thumbnails in addition to an existing set of thumbnails under personalization. It may be beneficial for creators to know the comparative performance between the two sets of thumbnails.

The MAB strategy module 712 may fetch MAB metadata (e.g., training data) based on the user cohort corresponding to the user from the MAB metadata database 720. Based on the MAB metadata, the MAB strategy module 712 may identify the thumbnail from the available thumbnails (from VE-thumbnail configuration service module 718) to serve to the user using the cohort-based MAB model 716.

Then, the client device 702 is requested to fetch the corresponding thumbnail from the thumbnail CDN 704. The thumbnail may be rendered in the corresponding grid tile at the client device 702. User engagement data associated with the virtual experience to which the thumbnail corresponds may be logged in user-engagement log database 706 for thumbnail-conversion rate analysis. An indication of the thumbnail selected for serving to the user by the cohort-based MAB model 716 may be stored in thumbnail serving log database 724.

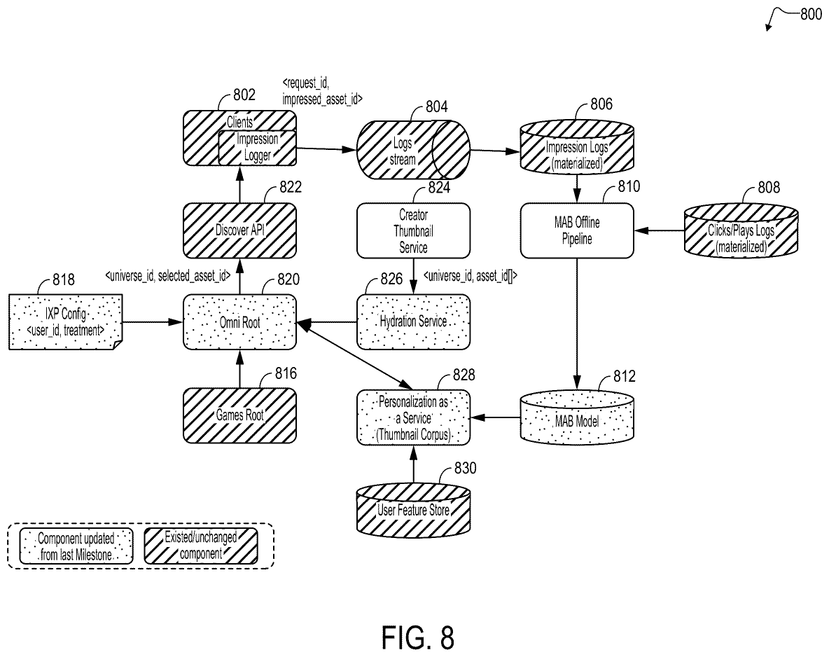

Example components to support the thumbnail-serving system 700 of FIG. 7 are described below with reference to FIG. 8.

### Example Online Serving Components for Second Stage (M2)

FIG. 8 is a diagram of thumbnail-serving system components 800, according to some implementations of the present disclosure.

Referring to FIG. 8, the thumbnail-serving system components 800 may be used to update the MAB model. To that end, the thumbnail-serving system components 800 may include, e.g., a client device 802, a logs stream module 804, an impression logs module 806, a click/plays logs module 808, an MAB offline pipeline module 810, an MAB model 812, a games root module 816, an IXP configuration module 818, an OmniRoot module 820, a discover API module 822, a creator thumbnail service module 824, a hydration service module 826, a personalization-as-a-service module 828, and a user feature store 830.

The client device 802 may include an impression logger that logs information associated with the display of a thumbnail. The impression logger may send the impression logs to logs stream module 804. Logs stream module 804 may store impression logs more efficiently than a regular data stream module, for instance. The impression logs may be sent to the impression logs module 806, which materializes the impression logs. An explanation of impression logs materialization is provided above with reference to FIG. 4 and will not be repeated here.

With user permission to collect and use such data, and in accordance with terms and conditions agreed to by a user associated with client device 802, the client device 802 may send click/plays information to clicks/plays log module 808, which may materialize the clicks/plays. The clicks/plays information may be materialized in the same or similar manner as impression logs and will not be repeated here.

The materialized impression logs and clicks/plays may be sent to MAB offline pipeline module 810. MAB offline pipeline module 810 may perform large-scale processes such as, e.g., data collection, an ETL process, feature generation, model training, etc. The MAB offline pipeline module 810 may perform these processes using the materialized impression logs and clicks/plays. For example, the materialized impression logs and clicks/plays may be used to update the training data set for MAB model 812. The various arms of the MAB model 812 may be updated based on the training data generated/updated by MAB offline pipeline module 810.

The creator thumbnail service module 824 may enable creators to upload a set of thumbnails for serving to users using the MAB model 812. The virtual-experience thumbnails may have corresponding metadata (e.g., universe_id, asset_id) that specifies the category (e.g., universe_id) of virtual experience and as well as a particular virtual experience (e.g., asset_id) within the category. The thumbnail metadata (<universe_id, asset_id[ ]>) may be sent to hydration service module 826.

Hydration service module 826 may perform hydration, which is a technique in which client-side JavaScript converts a web page that is static from the perspective of the web browser, delivered either through static rendering or server-side rendering, into a dynamic web page by attaching event handlers to the HTML elements in the document object model (DOM). For instance, hydration service module 826 will fetch thumbnail metadata (universe_id, thumbnail_asset_id) and render it to OmniRoot module 820, so that the algorithm will know the (universe_id, thumbnail_asset_id) mapping to construct the MAB algorithm and perform thumbnail personalization.

Personalization-as-a-service module 828 may use user features (e.g., associated with the user of client device 802) to identify the appropriate user cohort and the MAB model 812 to select a thumbnail from a thumbnail corpus (e.g., a plurality of thumbnails associated with the same virtual experience and uploaded by a creator).

The OmniRoot module 820 may receive selected thumbnail information from personalization-as-a-service module 828, games root information from games root module 416, user information (e.g., such as the impression for the user and the corresponding treatment <the user_id, treatment>) from an IXP configuration module 818 (e.g., a hosting control panel for Linux). The OmniRoot module 820 may identify a universe_id and selected_asset_id for the selected thumbnail based on the selected thumbnail information.

The universe_id and selected_asset_id may be sent to the discover API module 822. The discover API module 822 may provide information to the client device 802, which uses it to fetch and render the selected thumbnail.

### Example Offline Pipeline for Second Stage (M2)

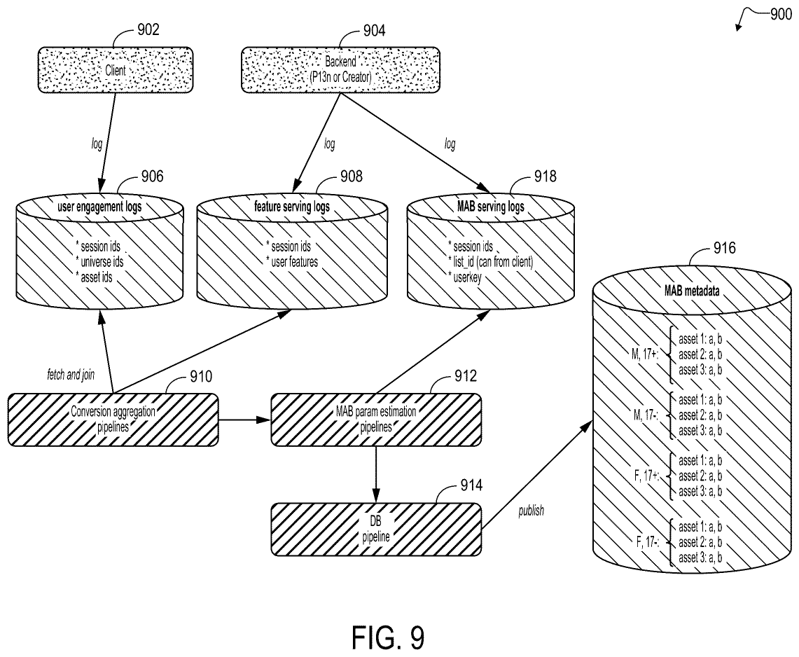

FIG. 9 is a diagram of example offline pipeline 900 for MAB, according to some implementations of the present disclosure.

Referring to FIG. 9, a goal of the offline pipeline 900 is to estimate the MAB parameters, e.g., alpha, beta for Thompson sampling, based on users' implicit or explicit feedback, etc. It may conduct aggregation and calculation based on the logged data and publishes the parameters to a database for serving. To that end, the offline pipeline 900 may include, e.g., a client device 902, a backend module 904 (e.g., either p13n or creator), a user engagement logs database 906, a feature serving logs database 908, conversion aggregation pipelines module 910, an MAB parameter estimation pipelines module 912, a database pipeline 914, and an MAB metadata database 916.

The client device 902 may include an impression logger (not shown) that logs information associated with the display of a thumbnail, implemented with appropriate user permissions as described above. The client device 902 may send the impression logs to the user engagement logs database 906. The impression logs may include information such as a session identification (e.g., a particular user session of the virtual-experience platform, date, time, duration, etc.), universe identification (e.g., the category of virtual experience the user wishes to engage with such as an adventure virtual experience), and the asset identification (e.g., a specific virtual experience within the broader virtual experience category).

The backend module 904 includes backend functionality that enables customization of feature serving logs (e.g., customization of tables by adjusting columns, sorting, filtering, grouping, etc.) and MAB serving logs (e.g., session ids, list id, userkey, etc.). This allows the display and behavior of performance data to be tailored for a creator's needs. The feature serving logs may be sent to feature serving logs database 908, and the MAB serving logs may be sent to MAB serving logs database 918. The features maintained by feature serving logs database 908 may be used to test a new feature update to the MAB model. This feature can be computed and fetched online alongside the other features that the MAB model will use for inference. The thumbnail to be shown to the user can become the training events (impressions) and later can be joined in ground truth labels: thumbnail clicks. Because the logged set of features for each impression and the MAB serving logs is available, it can be used to train the MAB model with historically accurate data.

The conversion aggregation pipeline module 910 and the MAB parameter estimation pipeline module 912 are designed to be configurable to facilitate MAB parameter sweeping. The MAB parameter is semi-personalized at the user cohort level. Each user cohort and each thumbnail may have a dedicated MAB model arm with parameters estimated according to the historical user engagement. In one non-limiting example, the users may be segmented into 4 cohorts: female 17+ (e.g., greater than 17-years-old), male 17+, female 17− (e.g., less than 17-years-old), and male 17−. A preliminary sample size calculation (e.g., MAB offline evaluation metric baseline and sample size calculation) indicates that the top 500 experiences may a sufficient amount of user traffic to obtain statically-significant results. These results may be published into database publish pipeline 914, as the corresponding data retrieval logic is mature on the backend side. The database pipeline 914 may publish the results to MAB metadata database 916.

Referring to FIG. 9, the offline pipeline design for cohort-based personalization may take into account the dynamic uploading/removal of thumbnails, the lower and upper bound of number of thumbnails, isolated MAB parameter estimation, and hourly MAB updating.

The MAB parameter estimation pipeline module 912 may update MAB parameters each time the creator updates (added/removed) a new thumbnail. A new list id may be generated for each list update event. The new list id may be sent to the MAB serving logs database 918. Creator service may pass back a unique set id and the corresponding create timestamp. On the serving side, the served set id may be logged (either client device 902 or backend module 904) and a timestamp may be created.

A creator remove/upload thumbnails any time they want. The changes may be picked up by the next scheduled pipeline job (e.g., 1+day delay in M2). At the serving time, when a new thumbnail does not yet have MAB parameters, the default parameters (e.g., 50% estimated conversion rate or any customized prior) may be used. The new MAB arm based on the default parameters arm may have very large variance due to lack of observation.

There is no limit on the number of thumbnails that can be uploaded by a creator (or generated and associated with a virtual experience), but in the second stage (M2) it may be beneficial to use a modest number of thumbnails, e.g., 5-10. This is because too few thumbnails may be insufficient for personalization, while too many thumbnails may hardly converge (for efficient personalized serving of thumbnails to different users) due to the cadence of daily (or another suitable frequency of) MAB parameter updates.

With the introduction of thumbnail sets, the offline pipeline may be aware of which set a thumbnail is in. The affiliation of the thumbnails is indicated by the flight_id. It is allowed that the same thumbnail can be in multiple sets. The converging speed of the MAB may be optimized.

### Creator-Side Services

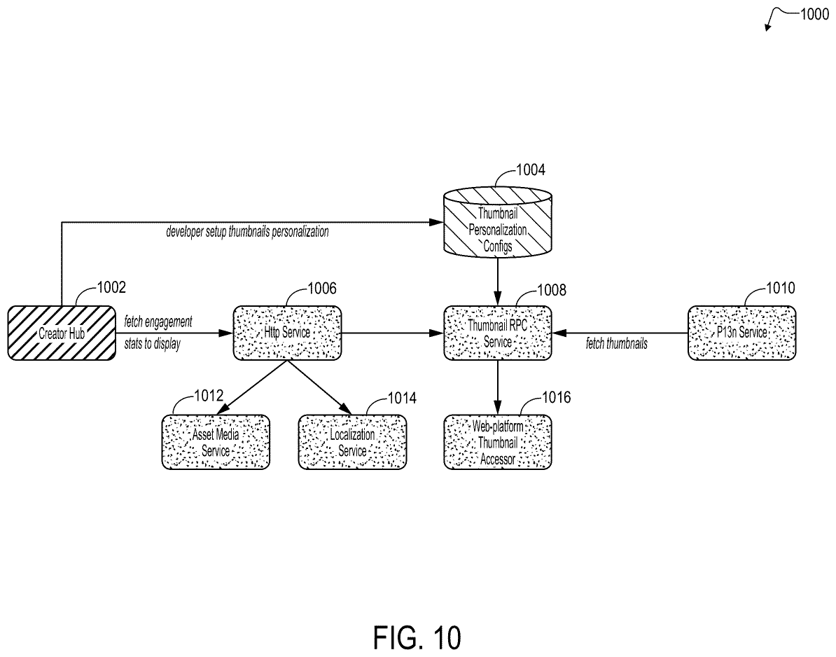

FIG. 10 is a diagram of creator-side service components 1000, according to some implementations of the present disclosure.

Referring to FIG. 10, creator-side service components 1000 may include serving and reporting, among others. To support the first and second stages, the creator side of the thumbnail-personalization system may provide various services set forth below. To provide the services described below, the creator-side service components 1000 may include, e.g., a creator hub module 1002, a thumbnail personalization configuration database 1004, an HTTP service module 1006, a thumbnail remote procedure call (RPC) service module 1008, a personalization service module 1010, an asset media service module 1012, a localization service module 1014, and a web-platform thumbnail accessor module 1016.

Referring to FIG. 10, a creator may access the creator hub module 1002 via a client device (not shown). The creator hub module 1002 may enable the creator to set up thumbnail personalization for her/his virtual experience. For instance, using the creator hub module 1002, a creator may upload/update/indicate the number of thumbnails for a corresponding virtual experience, configure different thumbnail sets for different user cohorts at thumbnail personalization configuration database 1004, configure different thumbnails for different languages, and/or turn on/off thumbnail personalization.

Moreover, the creator hub module 1002 may enable a user to upload a plurality of thumbnails associated with a virtual experience via HTTP service module 1006. The HTTP service module 1006 may enable a user to upload new thumbnails for running comparison studies. This HTTP service setup may be in the middle of the icon/thumbnail migration. The thumbnails uploaded by the user may be maintained by asset media service module 1012.

Different sets of thumbnails may be used for different languages, and the localization service module 1014 may determine which set of thumbnails to serve based on a user's location (accessed with user permission). In some implementations, to simplify thumbnail personalization simple and to avoid negatively impacting the over PTR, thumbnail personalization may be run in a default language.

The thumbnail RPC service module 1008 may enable a client device (not shown) to call functions on virtual-experience servers as if they were local. The thumbnails may be stored as assets and the asset_id may be stored in the thumbnail personalization configuration database 1004. The thumbnail personalization configuration database 1004 may have a JSON format that allows it to have detailed information about how the personalization may run. The information maintained by the thumbnail personalization configuration database 1004 may include, e.g., a start date, an end date, the number of thumbnails and the cohort to which they are to be served (e.g., for the first stage and the second stage it may be just the default language of the game).

The thumbnail RPC service module 1008 may connect to two different services: a discover application programming interface (API) (not shown) and the web-platform thumbnail accessor module 1016. For instance, when there is a request to load thumbnails, the thumbnail RPC service module 1008 may call discover API to provide the user id and thumbnail ids to ask the discover API to tell it which thumbnail should be served. The web-platform thumbnail accessor module 1016 is the centralized service to serve thumbnails.

The first stage (M1) and second stage (M2) described above in connection with FIGS. 2-10 support restricted personalization. To fully enable personalization, a third stage (M3), e.g., contextual MAB may be implemented. The third stage (M3) may include, e.g., contextual SoftMax exploration and contextual Thompson sampling with regularized logistic regions.

Contextual SoftMax exploration may include operations, e.g., such as preparing the MAB model, sampling and serving thumbnails, observing the reward for the served thumbnail, and updating the MAB model. Preparing the model may be similar to s-greedy. In some implementations, parametric and probability matching models may be used. To sample and serve, for each arm of the MAB mode, an inference on the model may be performed. The last layer (after SoftMax) of the model may indicate the probability distribution of rewards for each arm. Then, an arm may be sampled based on the distribution and serve the corresponding icon. The reward may be observed and the MAB model may be updated in a way similar to E-greedy.

Contextual Thompson sampling with regularized logistic regression may include operations, e.g., such as preparing the MAB model, sampling and serving thumbnails, observing the reward for the served thumbnail, and updating the MAB model. Preparing the model may use a regularized logistic regression to predict the reward. The uncertainty of the prediction may be described by the distribution of the MAB model weights (coefficients), which may be assumed to follow a Normal distribution. To sample and serve, a predicted reward is generated from the regularized logistic regression model with weights drawn from the Normal posterior distributions. The arm of the MAB model with the maximum generated reward may be selected. The user engagement data may be observed and logged for the selected thumbnail. The MAB model may be updated similar to ε-greedy.

In some implementations, alternative approaches may be used for contextual MAB, e.g., such as Parametric Linear Upper Confidence Bound (LinUCB) approach and Deep Learning with Uncertainty Measure (e.g., Bayesian neural network or Evidential Deep Learning).

To optimize the potential of contextual MAB, it may be beneficial to accelerate model convergence speed. Additionally, there is negative correlation between the complexity (feature and model structure) of the MAB model and the convergence speed of MAB. To unblock using more context, it may be beneficial to enable online learning of the model.

With the introduction of contextual MAB, adding more context may help the MAB model better capture the user behavior change, and thus, result in a more targeted personalization. With contextual MAB, all the available attributes in this list may be leveraged as context.

In some implementations, whether the stationary assumption holds for the reward metric for thumbnails (e.g., if the thumbnail PTR remains stable across time) may be determined. If this assumption does not hold, and the standard MAB with stationary assumption produces a biased result, non-stationary MAB methods may be used. Non-stationary MAB techniques may include, e.g., stochastic MAB or sliding window MAB.

The thumbnail personalization techniques described herein may be implemented with a binary reward function (such as PTR), but if a continuous reward metric is of interest (such as playtime or user-dollars spent), then Gaussian Thompson sampling may additionally or alternatively be used.

In case the contextual approach requires more advanced contextual features, such as user features from Frost, the MAB serving component may be moved from OmniRoot to a dedicated service, which is optimized and more suitable for generic personalization ranking. The thumbnail-personalization serving may be implemented as Personalization-as-a-Service (PaaS) as a longer-term solution.

### First Example Serving Backend and Data Infrastructure

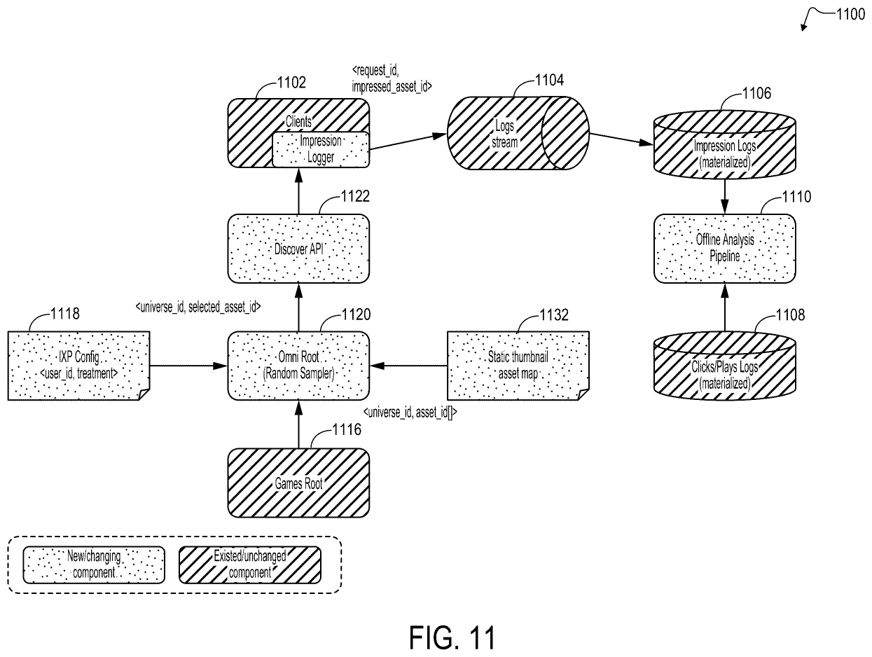

FIG. 11 is a diagram of thumbnail-serving system components 1100, according to some implementations of the present disclosure.

Referring to FIG. 11, the thumbnail-serving system components 1100 may be used to update the MAB model. To that end, the thumbnail-serving system components 1100 may include, e.g., a client device 1102, a logs stream module 1104, an impression logs module 1106, a click/plays logs module 1108, an offline analysis pipeline module 1110, a games root module 1116, an IXP configuration module 1118, an OmniRoot module 1120, a discover API module 1122, and a static thumbnail asset map module 1132. The thumbnail-serving system components 1100 may be used for one or more of the first stage (M1), the first substage (M1a), the second substage (M1b), or the second stage (M2).

In some implementations, referring to FIG. 11, in order to serve different thumbnails to different users in a static way, the following operations may be performed for thumbnail personalization.

For example, the client device 1102 may fetch thumbnails by backend recommended universe ids from discover API module 1122 directly, so the personalization backend has no control over which thumbnail to show to the users. To enable backend determined thumbnails, the following changes may be implemented for the personalization serving stack.

For instance, OmniRoot module 1120 may read a static configuration from static thumbnail asset map module 1132 for a map of <universe_id, personalizable_thumbnail_asset_ids>. For a treatment query from IXP configuration module 1118, OmniRoot module 1120 may randomly sample a thumbnail according to the configuration map and includes the thumbnail asset_id as part of the virtual-experience metadata. The metadata associated with the backend-identified thumbnail is returned to the client device 1102 via discover API module 1122 (with API contract updates).

The client device 1102 may retrieve the thumbnail according to the backend determined asset id. In case the asset_id is missing from the backend response, the default thumbnail (via legacy thumbnail fetching path) may be used. The client device 1102 logs the impressed thumbnail asset id in addition to existing impression metadata in the impression logs module 1106 via the logs stream module 1104.

Since a small-scale test is performed during the first stage (M1), the virtual experience-to-thumbnail mapping can be supplied as a static configuration directly to the OmniRoot module 1120 from runtime-configuration thumbnail personalization for a few target experiences. In some instances, the case the icon_id field may be empty.

After the effectiveness of personalization concept is shown using the canary test in the first stage (M1), a larger scale test can be supported with the following changes.

For instance, instead of fetching the personalized thumbnails per virtual experience from static thumbnail asset map module 1132, the OmniRoot module 1120 may retrieve the thumbnail asset list from a live backend instead. To that end, the current personalization serving stack may be modified as follows.

For example, the game metadata retrieval operation may be moved from discover API module 1122 to OmniRoot module 1120. In other words, hydration is called directly from the OmniRoot module 1120 instead of the discover API module 1122. Hydration fetches a list of personalized thumbnails per experience online.

Then, the cohort-based MAB model (not shown) and algorithm may be reimplemented with the contextual MAB approach.

### Second Example Serving Backend and Data Infrastructure

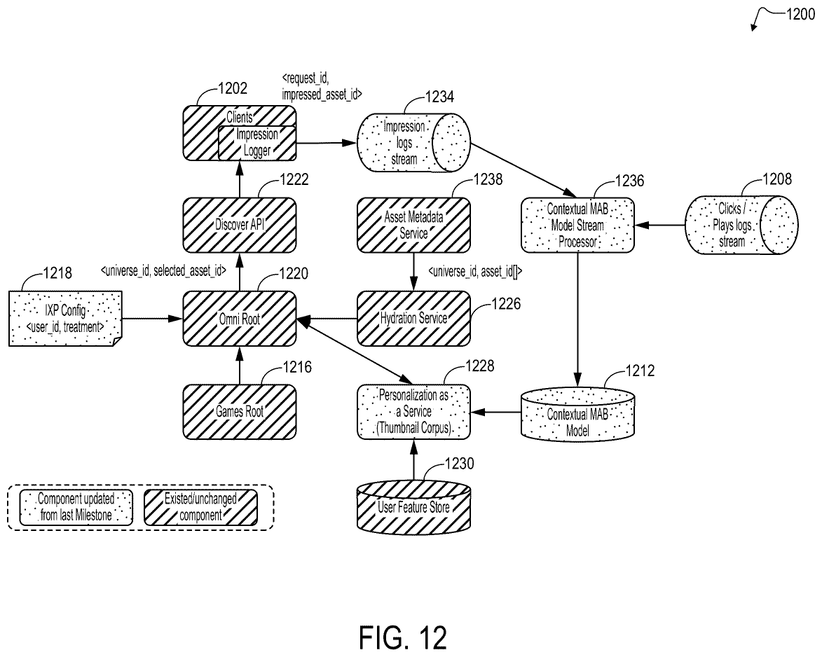

FIG. 12 is a diagram of thumbnail-serving system components 1200, according to some implementations of the present disclosure.

Referring to FIG. 12, the thumbnail-serving system components 1200 may be used to update the MAB model. To that end, the thumbnail-serving system components 1200 may include, e.g., a client device 1202, a click/plays logs stream module 1208, a contextual MAB model 1212, a games root module 1216, an IXP configuration module 1218, an OmniRoot module 1220, a discover API module 1222, a hydration service module 1226, a personalization-as-a-service module 1228, a user feature store 1230, an impression logs stream module 1234, a contextual MAB model stream processor 1236, and an asset metadata service module 1238.

The client device 1202 may include an impression logger that logs information associated with the display of a thumbnail. The impression logger may send the impression logs to impression logs stream module 1204. Impression logs stream module 1204 may store impression logs more efficiently than a regular data stream module, for instance. The impression logs may or may not be materialized by impression logs stream module 1204. An explanation of impression logs materialization is provided above with reference to FIG. 4 and will not be repeated here.

With user permission, the client device 1202 may send click/plays information to clicks/plays logs stream module 1208, which may materialize the clicks/plays. The clicks/plays information may be materialized in the same or similar manner as impression logs and will not be repeated here.

The materialized impression logs and clicks/plays, together with game id and user id (to be used for joining user attributes later for personalization), may be sent to contextual MAB model stream processor 1236. The contextual MAB model stream processor 1236 may perform large-scale processes such as, e.g., data collection, an extract/transform/load (ETL) process, feature generation, model training, etc. The contextual MAB model stream processor 1236 may perform these processes using the materialized impression logs and clicks/plays. For example, the materialized impression logs and clicks/plays may be used to update the training data set for contextual MAB model 1212. The various arms of the contextual MAB model 1212 may be updated based on the training data generated/updated by contextual MAB model stream processor 1236.

The asset metadata service module 1238 may enable creators to upload a set of thumbnails for serving to users using the contextual MAB model 1212. The virtual-experience thumbnails may have corresponding metadata (e.g., universe_id, asset_id) that specifies the category (e.g., universe) of virtual experience and as well as a particular virtual experience (associated with the creator) within the category. The thumbnail metadata (<universe_id, asset_id[ ]>) may be sent to hydration service module 1226.

Hydration service module 1226 may perform hydration, which is a technique in which client-side JavaScript converts a web page that is static from the perspective of the web browser, delivered either through static rendering or server-side rendering, into a dynamic web page by attaching event handlers to the HTML elements in the DOM.

Personalization-as-a-service module 1228 may use user features (e.g., associated with the user of client device 1202) to identify the appropriate user cohort and the contextual MAB model 1212 to select a thumbnail from a thumbnail corpus (e.g., a plurality of thumbnails associated with the same virtual experience and uploaded by a creator).

The OmniRoot module 1220 may receive selected thumbnail information from personalization-as-a-service module 1228, games root information from games root module 1216, user information (e.g., such as the impression for the user and the corresponding treatment <the user_id, treatment>) from an IXP configuration module 1218. The OmniRoot module 1220 may identify a universe_id and selected_asset_id for the selected thumbnail based on the selected thumbnail information.

The universe_id and selected_asset_id may be sent to the discover API module 1222. The discover API module 1222 may provide information the client device 1202 uses to fetch and render the selected thumbnail.

### Example Method(s) of Thumbnail Personalization

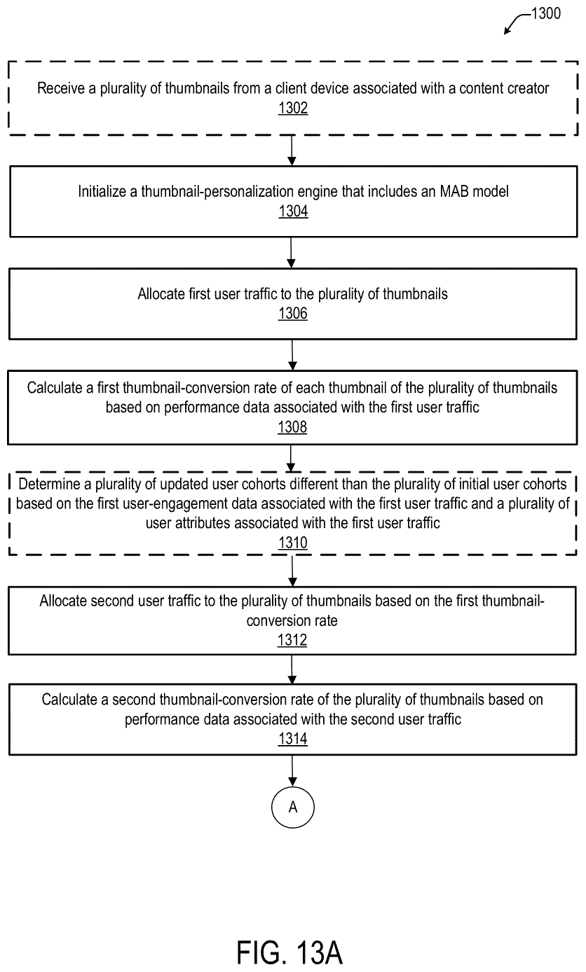

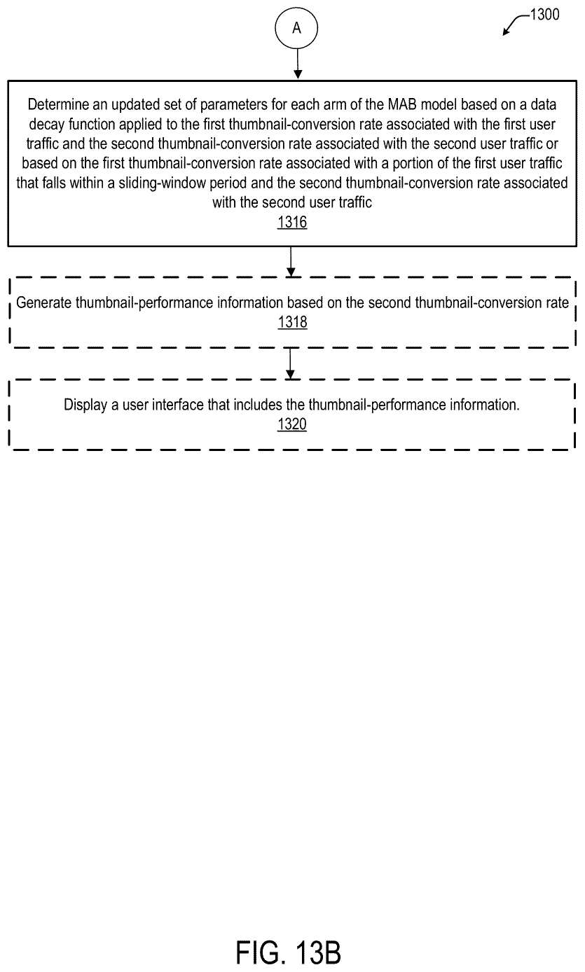

FIGS. 13A and 13B are a flowchart of an example method 1300 of mesh-deformation prediction, in accordance with some implementations.

In some implementations, methods 1300 can be implemented, for example, on an online virtual experience server 102 described with reference to FIG. 1. In some implementations, some or all of the method 1300 can be implemented on one or more client devices 110 as shown in FIG. 1, on one or more developer devices (not illustrated), or on one or more online virtual experience server(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 1300. In some examples, a first device is described as performing blocks of method 1300. Some implementations can have one or more blocks of method 1300 performed by one or more other devices (e.g., other client devices or server devices) that can send results or data to the first device.

In some implementations, method 1300, or portions of the methods, can be initiated automatically by a system. In some implementations, the implementing system is a first device. For example, the method (or portions thereof) can be periodically performed, or performed based on one or more particular events or conditions, e.g., upon a user request, upon an uploading of thumbnails, upon a change in thumbnails, upon a predetermined time period having expired since the last performance of method 1300 for a particular set of thumbnails, and/or one or more other conditions occurring which can be specified in settings read by the methods.

Referring to FIG. 13A, method 1300 may begin at block 1302. At block 1302, a plurality of thumbnails may be received from a client device associated with a content creator.

Block 1302 may be followed by block 1304. At block 1304, a thumbnail-personalization engine that includes an MAB model may be initialized. Each arm in the MAB model may correspond to a respective thumbnail of a plurality of thumbnails associated with a virtual experience and a respective initial user cohort of a plurality of initial user cohorts.

In some implementations, the virtual experience is hosted on a virtual experience platform, and the virtual experience is associated with a particular content creator.

Block 1304 may be followed by block 1306. At block 1306, first user traffic may be allocated to the plurality of thumbnails. Each thumbnail may receive a respective proportion of the first user traffic.

In some implementations, allocating the first user traffic to the plurality of thumbnails may include assigning each user associated with the first user traffic to a corresponding initial user cohort of a plurality of initial user cohorts based on at least one first user attribute associated with the user.

In some implementations, allocating the first user traffic to the plurality of thumbnails may include allocating respective portions of the first user traffic to respective thumbnails of the plurality of thumbnails based on the corresponding initial user cohort such that the plurality of thumbnails is allocated to the first user traffic in a uniform distribution.

Block 1306 may be followed by block 1308. At block 1308, a first thumbnail-conversion rate of each thumbnail of the plurality of thumbnails may be calculated based on performance data associated with the first user traffic.

In some implementations, calculating the first thumbnail-conversion rate of the plurality of thumbnails based on data associated with the first user traffic may include receiving first user-engagement data associated with the first user traffic.

In some implementations, calculating the first thumbnail-conversion rate of the plurality of thumbnails based on data associated with the first user traffic may include, for each initial user cohort of the plurality of initial user cohorts, determining the first thumbnail-conversion rate of respective ones of the plurality of thumbnails based on the first user-engagement data.

In some implementations, calculating the first thumbnail-conversion rate of the plurality of thumbnails based on data associated with the first user traffic may include determining an initial set of parameters for each arm of the MAB model based on the first thumbnail-conversion rate.

Block 1308 may be followed by block 1310. At block 1310, a plurality of updated user cohorts different than the plurality of initial user cohorts may be determined based on the first user-engagement data associated with the first user traffic and a plurality of user attributes associated with the first user traffic.

In some implementations, the plurality of user attributes may include age, location, language, gender, account tenure, device platform, historical user engagement data, playtime, types of virtual experiences the user has engaged with, click-through rate on virtual-experience recommendations, or any combination thereof.

In some implementations, determining the plurality of updated user cohorts may include determining a respective HIE feature importance score for each user attribute of the plurality of user attributes associated with the first user traffic based on a contribution of a particular user attribute to an incremental gain achieved by heterogeneous best arms of the MAB model compared to a global best arm of the MAB model. In some implementations, determining the plurality of updated user cohorts may include determining the plurality of updated user cohorts based on the respective HIE feature importance score for each user attribute of the plurality of user attributes associated with the first user traffic.

In some implementations, determining the plurality of updated user cohorts may include determining a respective HDD feature importance score for each user attribute of the plurality of user attributes associated with the first user traffic based on a distribution divergence heterogeneity introduced by a particular user attribute. In some implementations, determining the plurality of updated user cohorts may include determining the plurality of updated user cohorts based on the respective HDD feature importance score each user attribute of the plurality of user attributes associated with the first user traffic.

Block 1310 may be followed by block 1312. At block 1312, second user traffic may be allocated to the plurality of thumbnails based on the first thumbnail-conversion rate such that the MAB model allocates a larger proportion of the second user traffic to a first thumbnail of the plurality of thumbnails with a highest first thumbnail-conversion rate and a smaller proportion of the second user traffic to a second thumbnail of the plurality of thumbnails with a lower first thumbnail-conversion rate.

In some implementations, allocating the second user traffic to the plurality of thumbnails based on the first thumbnail-conversion rate using the MAB model may include, for each user associated with the second user traffic, determining a corresponding updated user cohort of the plurality of updated user cohorts based on one or more second user attributes. In some implementations, allocating the second user traffic to the plurality of thumbnails based on the first thumbnail-conversion rate using the MAB model may include allocating respective portions of the second user traffic to respective thumbnails of the plurality of thumbnails based the updated user cohorts.

Block 1312 may be followed by block 1314. At block 1314, a second thumbnail-conversion rate of the plurality of thumbnails may be calculated based on performance data associated with the second user traffic.

In some implementations, calculating the second thumbnail-conversion rate of the plurality of thumbnails based on the performance data associated with the second user traffic may include receiving second user-engagement data associated with the second user traffic and the plurality of thumbnails. In some implementations, calculating the second thumbnail-conversion rate of the plurality of thumbnails based on the performance data associated with the second user traffic may include, for each updated user cohort of the plurality of updated user cohorts, determining the second thumbnail-conversion rate of the plurality of thumbnails based on the second user-engagement data.

Referring to FIG. 13B, block 1314 may be followed by block 1316. At block 1316, an updated set of parameters for each arm of the MAB model may be determined based on a data decay function applied to the first thumbnail-conversion rate associated with the first user traffic and the second thumbnail-conversion rate associated with the second user traffic or based on the first thumbnail-conversion rate associated with a portion of the first user traffic that falls within a sliding-window period and the second thumbnail-conversion rate associated with the second user traffic.

In some implementations, determining the updated set of parameters for each arm of the MAB model based on the data decay function may include applying a first weighted value to the first thumbnail-conversion rate associated with the first user traffic to determine a first weighted thumbnail-conversion rate. In some implementations, determining the updated set of parameters for each arm of the MAB model based on the data decay function may include applying a second weighted value to the second thumbnail-conversion rate associated with the second user traffic to determine a second weighted thumbnail-conversion rate, the second weighted value being larger than the first weighted value. In some implementations, determining the updated set of parameters for each arm of the MAB model based on the data decay function may include determining the updated set of parameters for each arm of the MAB model based on the first weighted thumbnail-conversion rate and the second weighted thumbnail-conversion rate.

Block 1316 may be followed by block 1318. At block 1318, thumbnail-performance information may be generated based on the second thumbnail-conversion rate.

Block 1318 may be followed by block 1320. At block 1320, a user interface that includes the thumbnail-performance information may be displayed.

In some implementations, displaying the user interface may include displaying the user interface at the client device to the content creator.

### Computing Devices

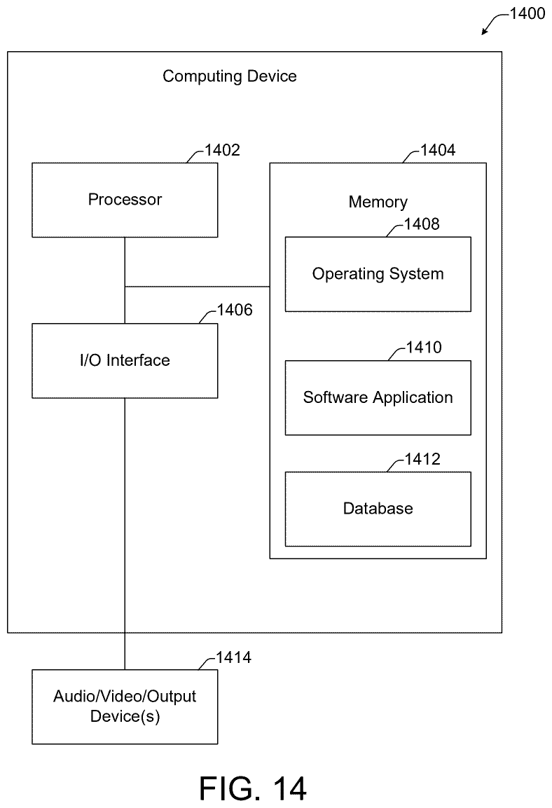

Hereinafter, a more detailed description of various computing devices that may be used to implement different devices and/or components illustrated in FIG. 1 is provided with reference to FIG. 14.

FIG. 14 is a block diagram of an example computing device 1400 which may be used to implement one or more features described herein, in accordance with some implementations. In one example, computing device 1400 may be used to implement a computer device, (e.g., 102, 100 of FIG. 1), and perform appropriate operations as described herein. Computing device 1400 can be any suitable computer system, server, or other electronic or hardware device. For example, the computing device 1400 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, computing device 1400 includes a processor 1402, a memory 1404, input/output (I/O) interface 1406, and audio/video input/output devices 1414 (e.g., display screen, touchscreen, display goggles or glasses, audio speakers, headphones, microphone, etc.).

Processor 1402 can be one or more processors and/or processing circuits to execute program code and control basic operations of the computing device 1400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1404 is typically provided in computing device 1400 for access by the processor 1402, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1402 and/or integrated therewith. Memory 1404 can store software operating on the computing device 1400 by the processor 1402, including an operating system 1408, software application 1410, and associated database 1412. In some implementations, the software application 1410 can include instructions that enable processor 1402 to perform the functions described herein. Software application 1410 may include some or all of the functionality described herein.

In some implementations, one or more portions of software application 1410 may be implemented in dedicated hardware such as an application-specific integrated circuit (ASIC), a programmable logic device (PLD), a field-programmable gate array (FPGA), a machine learning processor, etc. In some implementations, one or more portions of software application 1410 may be implemented in general purpose processors, such as a central processing unit (CPU) or a graphics processing unit (GPU). In various implementations, suitable combinations of dedicated and/or general-purpose processing hardware may be used to implement software application 1410.

For example, software application 1410 stored in memory 1404 can include instructions for implementing any of the above-described operations and/or techniques. Any of software in memory 1404 can alternatively be stored on any other suitable storage location or computer-readable medium. In addition, memory 1404 (and/or other connected storage device(s)) can store instructions and data used in the features described herein. Memory 1404 and any other type of storage (magnetic disk, optical disk, magnetic tape, or other tangible media) can be considered “storage” or “storage devices.”

One or more of operating system 1408, software application 1410, and database 1412 may provide a distributed database suitable with support for spatial workloads, with capability to handle temporal data, to ensure data consistency, and/or with native support for speculation, per various implementations described herein.

I/O interface 1406 can provide functions to enable interfacing the computing device 1400 with other systems and devices. For example, network communication devices, storage devices (e.g., memory and/or data store 106), and input/output devices can communicate via interface 1406. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 14 shows one block for each of processor 1402, memory 1404, I/O interface 1406, operating system 1408, software application 1410, and database 1412. These blocks may represent one or more processors or processing circuitries, operating systems, memories, I/O interfaces, applications, and/or software modules. In other implementations, computing device 1400 may not have all of the components shown and/or may have other elements including other types of elements instead of, or in addition to, those shown herein. While the online virtual experience server 102 are described as performing operations as described in some implementations herein, any suitable component or combination of components of online virtual experience server 102, or similar system, or any suitable processor or processors associated with such a system, may perform the operations described.

A user device can also implement and/or be used with features described herein. Example user devices can be computer devices including some similar components as the computing device 1400, e.g., processor(s) 1402, memory 1404, and I/O interface 1406. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1414, for example, can be connected to (or included in) the computing device 1400 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more operations described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method of thumbnail personalization, comprising:
initializing, by a processor, a thumbnail-personalization engine that includes a multi-armed bandit (MAB) model, each arm in the MAB model corresponding to a respective thumbnail of a plurality of thumbnails associated with a virtual experience and a respective initial user cohort of a plurality of initial user cohorts;
allocating, by the processor, first user traffic to the plurality of thumbnails, wherein each thumbnail receives a respective proportion of the first user traffic;
calculating, by the processor, a first thumbnail-conversion rate of each thumbnail of the plurality of thumbnails based on performance data associated with the first user traffic;
allocating, by the processor, second user traffic to the plurality of thumbnails based on the first thumbnail-conversion rate such that the MAB model allocates a larger proportion of the second user traffic to a first thumbnail of the plurality of thumbnails with a highest first thumbnail-conversion rate and a smaller proportion of the second user traffic to a second thumbnail of the plurality of thumbnails with a lower first thumbnail-conversion rate;
calculating, by the processor, a second thumbnail-conversion rate of the plurality of thumbnails based on performance data associated with the second user traffic; and
determining, by the processor, at least one of:
an updated set of parameters for each arm of the MAB model based on a data decay function applied to the first thumbnail-conversion rate associated with the first user traffic and the second thumbnail-conversion rate associated with the second user traffic; or
the updated set of parameters for each arm of the MAB model based on the first thumbnail-conversion rate associated with a portion of the first user traffic that falls within a sliding-window period and the second thumbnail-conversion rate associated with the second user traffic.

2. The computer-implemented method of claim 1, further comprising:
receiving, by the processor, the plurality of thumbnails from a client device associated with a content creator;
generating, by the processor, thumbnail-performance information based on the second thumbnail-conversion rate; and
displaying, by the processor, a user interface that includes the thumbnail-performance information.

3. The computer-implemented method of claim 2, wherein:
the virtual experience is hosted on a virtual experience platform, and the virtual experience is associated with a particular content creator, and
displaying the user interface comprises displaying the user interface at the client device to the content creator.

4. The computer-implemented method of claim 1, wherein allocating the first user traffic to the plurality of thumbnails comprises:
assigning, by the processor, each user associated with the first user traffic to a corresponding initial user cohort of a plurality of initial user cohorts based on at least one first user attribute associated with the user; and
allocating, by the processor, respective portions of the first user traffic to respective thumbnails of the plurality of thumbnails based on the corresponding initial user cohort such that the plurality of thumbnails are allocated to the first user traffic in a uniform distribution.

5. The computer-implemented method of claim 4, wherein calculating the first thumbnail-conversion rate of the plurality of thumbnails based on data associated with the first user traffic comprises:
receiving, by the processor, first user-engagement data associated with the first user traffic;
for each initial user cohort of the plurality of initial user cohorts, determining, by the processor, the first thumbnail-conversion rate of respective ones of the plurality of thumbnails based on the first user-engagement data; and
determining, by the processor, an initial set of parameters for each arm of the MAB model based on the first thumbnail-conversion rate.

6. The computer-implemented method of claim 5, further comprising:
determining, by the processor, a plurality of updated user cohorts different than the plurality of initial user cohorts based on the first user-engagement data associated with the first user traffic and a plurality of user attributes associated with the first user traffic.

7. The computer-implemented method of claim 6, wherein the plurality of user attributes comprises age, location, language, gender, account tenure, device platform, historical user engagement data, playtime, types of virtual experiences the user has engaged with, click-through rate on virtual-experience recommendations, or any combination thereof.

8. The computer-implemented method of claim 6, wherein determining the plurality of updated user cohorts comprises:
determining, by the processor, a respective heterogeneous incremental effect (HIE) feature importance score for each user attribute of the plurality of user attributes associated with the first user traffic based on a contribution of a particular user attribute to an incremental gain achieved by heterogeneous best arms of the MAB model compared to a global best arm of the MAB model; and
determining, by the processor, the plurality of updated user cohorts based on the respective HIE feature importance score for each user attribute of the plurality of user attributes associated with the first user traffic.

9. The computer-implemented method of claim 6, wherein determining the plurality of updated user cohorts comprises:
determining, by the processor, a respective heterogeneous distribution divergence (HDD) feature importance score for each user attribute of the plurality of user attributes associated with the first user traffic based on a distribution divergence heterogeneity introduced by a particular user attribute; and
determining, by the processor, the plurality of updated user cohorts based on the respective HDD feature importance score each user attribute of the plurality of user attributes associated with the first user traffic.

10. The computer-implemented method of claim 6, wherein allocating the second user traffic to the plurality of thumbnails based on the first thumbnail-conversion rate using the MAB model comprises:
for each user associated with the second user traffic, determining, by the processor, a corresponding updated user cohort of the plurality of updated user cohorts based on one or more second user attributes; and
allocating, by the processor, respective portions of the second user traffic to respective thumbnails of the plurality of thumbnails based the updated user cohorts.

11. The computer-implemented method of claim 10, wherein calculating the second thumbnail-conversion rate of the plurality of thumbnails based on the performance data associated with the second user traffic comprises:
receiving, by the processor, second user-engagement data associated with the second user traffic and the plurality of thumbnails; and
for each updated user cohort of the plurality of updated user cohorts, determining, by the processor, the second thumbnail-conversion rate of the plurality of thumbnails based on the second user-engagement data.

12. The computer-implemented method of claim 1, wherein determining the updated set of parameters for each arm of the MAB model based on the data decay function comprises:
applying, by the processor, a first weighted value to the first thumbnail-conversion rate associated with the first user traffic to determine a first weighted thumbnail-conversion rate;
applying, by the processor, a second weighted value to the second thumbnail-conversion rate associated with the second user traffic to determine a second weighted thumbnail-conversion rate, the second weighted value being larger than the first weighted value; and
determining, by the processor, the updated set of parameters for each arm of the MAB model based on the first weighted thumbnail-conversion rate and the second weighted thumbnail-conversion rate.

13. A non-transitory computer-readable medium with instructions stored thereon that, when executed by a processor, cause the processor to perform operations comprising:
initializing a thumbnail-personalization engine that includes a multi-armed bandit (MAB) model, each arm in the MAB model corresponding to a respective thumbnail of a plurality of thumbnails associated with a virtual experience and a respective initial user cohort of a plurality of initial user cohorts;
allocating first user traffic to the plurality of thumbnails, wherein each thumbnail receives a respective proportion of the first user traffic;
calculating a first thumbnail-conversion rate of each thumbnail of the plurality of thumbnails based on performance data associated with the first user traffic;
allocating second user traffic to the plurality of thumbnails based on the first thumbnail-conversion rate such that the MAB model allocates a larger proportion of the second user traffic to a first thumbnail of the plurality of thumbnails with a highest first thumbnail-conversion rate and a smaller proportion of the second user traffic to a second thumbnail of the plurality of thumbnails with a lower first thumbnail-conversion rate;
calculating a second thumbnail-conversion rate of the plurality of thumbnails based on performance data associated with the second user traffic; and
determining at least one of:
an updated set of parameters for each arm of the MAB model based on a data decay function applied to the first thumbnail-conversion rate associated with the first user traffic and the second thumbnail-conversion rate associated with the second user traffic; or
the updated set of parameters for each arm of the MAB model based on the first thumbnail-conversion rate associated with a portion of the first user traffic that falls within a sliding-window period and the second thumbnail-conversion rate associated with the second user traffic.

14. The non-transitory computer-readable medium of claim 13, wherein:
allocating the first user traffic to the plurality of thumbnails comprises:
assigning, by the processor, each user associated with the first user traffic to a corresponding initial user cohort of a plurality of initial user cohorts based on at least one first user attribute associated with the user; and
allocating, by the processor, respective portions of the first user traffic to respective thumbnails of the plurality of thumbnails based on the corresponding initial user cohort such that the plurality of thumbnails are allocated to the first user traffic in a uniform distribution, and
calculating the first thumbnail-conversion rate of the plurality of thumbnails based on data associated with the first user traffic comprises:
receiving, by the processor, first user-engagement data associated with the first user traffic;
for each initial user cohort of the plurality of initial user cohorts, determining, by the processor, the first thumbnail-conversion rate of respective ones of the plurality of thumbnails based on the first user-engagement data; and
determining, by the processor, an initial set of parameters for each arm of the MAB model based on the first thumbnail-conversion rate.

15. The non-transitory computer-readable medium of claim 14, wherein the operations further comprise:
determining, by the processor, a plurality of updated user cohorts different than the plurality of initial user cohorts based on the first user-engagement data associated with the first user traffic and a plurality of user attributes associated with the first user traffic.

16. The non-transitory computer-readable medium of claim 15, wherein determining the plurality of updated user cohorts comprises:
determining, by the processor, a respective heterogeneous incremental effect (HIE) feature importance score for each user attribute of the plurality of user attributes associated with the first user traffic based on a contribution of a particular user attribute to an incremental gain achieved by heterogeneous best arms of the MAB model compared to a global best arm of the MAB model; and
determining, by the processor, the plurality of updated user cohorts based on the respective HIE feature importance score for each user attribute of the plurality of user attributes associated with the first user traffic.

17. The non-transitory computer-readable medium of claim 15, wherein determining the plurality of updated user cohorts comprises:
determining, by the processor, a respective heterogeneous distribution divergence (HDD) feature importance score for each user attribute of the plurality of user attributes associated with the first user traffic based on a distribution divergence heterogeneity introduced by a particular user attribute; and
determining, by the processor, the plurality of updated user cohorts based on the respective HDD feature importance score each user attribute of the plurality of user attributes associated with the first user traffic.

18. The non-transitory computer-readable medium of claim 13, wherein determining the updated set of parameters for each arm of the MAB model based on the data decay function comprises:
applying, by the processor, a first weighted value to the first thumbnail-conversion rate associated with the first user traffic to determine a first weighted thumbnail-conversion rate;
applying, by the processor, a second weighted value to the second thumbnail-conversion rate associated with the second user traffic to determine a second weighted thumbnail-conversion rate, the second weighted value being larger than the first weighted value; and
determining, by the processor, the updated set of parameters for each arm of the MAB model based on the first weighted thumbnail-conversion rate and the second weighted thumbnail-conversion rate.

19. A computing device, comprising:
a processor; and
memory, coupled to the processor, with instructions stored thereon that, when executed by the processor, cause the processor to perform operations comprising:
initializing a thumbnail-personalization engine that includes a multi-armed bandit (MAB) model, each arm in the MAB model corresponding to a respective thumbnail of a plurality of thumbnails associated with a virtual experience and a respective initial user cohort of a plurality of initial user cohorts;
allocating first user traffic to the plurality of thumbnails, wherein each thumbnail receives a respective proportion of the first user traffic;
calculating a first thumbnail-conversion rate of each thumbnail of the plurality of thumbnails based on performance data associated with the first user traffic;
allocating second user traffic to the plurality of thumbnails based on the first thumbnail-conversion rate such that the MAB model allocates a larger proportion of the second user traffic to a first thumbnail of the plurality of thumbnails with a highest first thumbnail-conversion rate and a smaller proportion of the second user traffic to a second thumbnail of the plurality of thumbnails with a lower first thumbnail-conversion rate;
calculating a second thumbnail-conversion rate of the plurality of thumbnails based on performance data associated with the second user traffic; and
determining at least one of:
an updated set of parameters for each arm of the MAB model based on a data decay function applied to the first thumbnail-conversion rate associated with the first user traffic and the second thumbnail-conversion rate associated with the second user traffic; or
the updated set of parameters for each arm of the MAB model based on the first thumbnail-conversion rate associated with a portion of the first user traffic that falls within a sliding-window period and the second thumbnail-conversion rate associated with the second user traffic.

20. The computing device of claim 19, wherein determining the updated set of parameters for each arm of the MAB model based on the data decay function comprises:
applying, by the processor, a first weighted value to the first thumbnail-conversion rate associated with the first user traffic to determine a first weighted thumbnail-conversion rate;
applying, by the processor, a second weighted value to the second thumbnail-conversion rate associated with the second user traffic to determine a second weighted thumbnail-conversion rate, the second weighted value being larger than the first weighted value; and
determining, by the processor, the updated set of parameters for each arm of the MAB model based on the first weighted thumbnail-conversion rate and the second weighted thumbnail-conversion rate.
